(19) United States
(12) Patent Application Publication
(10) Pub. No.: US 2025/0371538 A1
(43) Pub. Date: Dec. 4, 2025

(54) SYSTEMS AND METHODS FOR INTEGRATING THREE-DIMENSIONAL VIRTUALIZATION SYSTEMS WITH TRANSACTION SYSTEMS

(71) Applicant: TMRW FOUNDATION IP S.ÀR.L., Luxembourg (LU)

(72) Inventors: Cevat YERLI, Dubai (AE); Gregory Peter MORWOOD, Dubai (AE)

(21) Appl. No.: 18/731,008

(22) Filed: May 31, 2024

(51) Int. Cl. G06Q 20/40; G06T 11/20; G06T 15/00; G06T 19/00

(52) U.S. Cl. CPC G06Q 20/401; G06T 11/206; G06T 15/00; G06T 19/00; G06T 2219/024

(57) ABSTRACT

This disclosure relates to integrating three-dimensional (3D) virtualization systems with transaction systems. A virtualization system can be configured to host a live virtual session in a 3D virtualization environment that facilitates collaborations and interactions among remotely situated end-user participants. A 3D engine associated with the virtualization system generates the 3D virtualization environment, as well as virtual user representations and transactional infographics that are inserted into the 3D virtualization environment. The virtualization system communicates with a transaction system to retrieve transaction data for generating the transactional infographics presented in the 3D virtual environment and/or to initiate or execute electronic transactions. Other embodiments are disclosed herein as well.

### TECHNICAL FIELD

This disclosure is related to systems, methods, and techniques for generating three-dimensional (3D) virtual environments that enable collaboration among a plurality of virtual participants. In certain embodiments, a 3D engine generates transactional infographics based on a virtual user's transaction data, inserts the transactional infographics into a virtual environment, and configures the transactional infographics to display data visualizations related to the transaction data. Additionally, in some embodiments, the transactional infographics and/or other features of the virtual environment also can be configured with functionalities that enable electronic transactions to be initiated or executed directly within the virtual environment.

### BACKGROUND ART

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions, or is known to be relevant to an attempt to solve any problem with which this specification is concerned.

In recent years, global pandemics and societal influences have forced mobility restrictions worldwide and changed the manner in which meeting, learning, shopping, and working take place. This growing trend has placed a greater importance on remote collaboration and interactions. Various solutions are already available in the market to enable real-time communication and collaboration, ranging from chat applications to video telephony, such as Skype™ and Zoom™ or virtual offices for remote teams represented by 2D avatars, such as those provided by Pragli™.

Other potential solutions to accommodate this growing trend include usage of wearable immersive technologies (e.g., augmented and/or virtual reality solutions). However, given the current state of development of wearable immersive technologies and the relatively low technological appropriation rate, these wearable immersive technologies are used to a much lesser extent. Rather, most remote technology solutions include a flat, two-dimensional (2D) user interface that provides end-users with opportunities to interact or collaborate. However, these 2D environments are plagued with various deficiencies, such as low levels of realism, lack of user presence, and lack of shared space. Additionally, most of these 2D solutions are configured solely with communication capabilities and, thus, require end-users to share screens or utilize separate applications to effectively relay information or collaborate during remote collaboration sessions. Moreover, compared to real-life (or in-person) collaboration or interactions, the quality of interactions using 2D solutions can contribute to a feeling of dullness or boredom for many users, which, in turn, can result in a lower productivity or diminished collaboration.

In view of the foregoing, there is a need for a technological framework that enables end-users to remotely interact and collaborate in a virtual environment that provides a feeling of realism akin to in-person interactions without being required to purchase expensive immersive technology equipment (e.g., as in head-mounted displays). Additionally, there is a need for a technological framework that enables end-users to initiate or execute electronic transactions directly within a virtual environment, without the need to access, launch or utilize separate applications to facilitate the electronic transactions.

While certain aspects of conventional technologies have been discussed to facilitate disclosure of the invention, Applicant in no way disclaims these technical aspects, and it is contemplated that the claimed invention may encompass or include one or more of the conventional technical aspects discussed herein.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure generally relates to technological frameworks for facilitating collaboration in three-dimensional (3D) virtual environments and executing or initiating electronic transactions within the 3D virtual environments. In certain embodiments, a virtual transaction platform comprises a virtualization system that is adapted to render 3D virtual environments in which end-users can collaborate and interact with each other, and a transaction system that facilitates access to transaction data and processes electronic transactions based on interactions within the 3D virtual environments. In contrast to many traditional 2D remote solutions, the virtual transaction platform facilitates collaboration and interactions among remote participants in a 3D setting that is akin to real-world or in-person meetings, and permits electronic transactions to be executed or initiated directly within a 3D virtual environment without having to access or launch separate applications.

In some embodiments, the virtualization system comprises a 3D engine that is configured to generate, create, and/or render a virtual environment by generating objects (e.g., 2D or 3D objects) corresponding to virtual user representations and transactional infographics, and integrating those objects into a virtual scene. The 3D engine can receive and process data from various sources to render a virtual environment. For example, the 3D engine can be adapted to receive and process image data, such as real-time audio/video streams, from computing devices associated with end-users to generate and insert virtual user representations corresponding to the end-users into a virtual scene. Additionally, the 3D engine can be adapted to receive and process transaction data from a transaction system to generate and insert infographics into the virtual scene. The 3D engine also can access scene configuration data (e.g., data identifying dimensions of a virtual room, stationary virtual objects to be included in the scene, virtual camera perspective information etc.) that aids the 3D engine in creating the background or setting associated with the virtual scene and configuring virtual camera viewing perspectives for displaying the virtual scene on computing devices operated by end-users. The 3D engine can integrate the virtual user representations, infographics, and scene configuration data to create a virtual environment in which the end-users view, access, and manipulate the transaction data, and execute or initiate electronic transactions corresponding to the transaction data. The virtual environment can be transmitted to, or accessed by, the computing devices operated by the end-users.

During a given virtual session, the end-users (or corresponding virtual user representations) can interact with one or more infographics integrated into the virtual environment in various ways. In some examples, an infographic can be generated based, at least in part, on the transaction data associated with an end-user (e.g., a client end-user) that is received from the transaction system. The infographic can comprise one or more objects that visualize or summarize the transaction data associated with the end-user (e.g., using 3D graphs, data plots, graphical illustrations, etc.). Additionally, the infographic can comprise one or more objects that display or visualize analytics related to an end-user's transaction data (e.g., analytics that assess risks associated with the transaction data, generate projections or predictions related to the transaction data, display recommendations related to the transaction data, etc.). Further, in some embodiments, the infographics (and/or other virtual objects) included in the virtual environment can enable the virtual participants to initiate and/or execute various types of electronic transactions. As explained in further detail below, the types of electronic transactions can vary depending on the products or services associated with the transaction system (or the products or services offered by a provider of the transaction system).

The virtualization technologies described herein have wide applicability and can be utilized across various types of transaction systems. In some non-limiting examples, the transaction system can correspond to an electronic banking system and/or electronic financial services system that stores financial transaction data (e.g., bank account information, asset allocations, stock portfolios, retirement funds, etc.) of client end-users. The 3D engine can access this financial transaction information from a financial transaction system, and incorporate the financial transaction data into infographics that visualize the client end-users' financials in a 3D virtual environment. The 3D engine can further generate infographics that display analytics (e.g., risk exposure, projections, predictions, etc.) and/or recommendations related to the end-use's financial transaction data. Additionally, the infographics and/or other components in the virtual environment can be configured with functionalities that enable the end-users (e.g., platform end-users) to initiate or execute electronic transactions related to the financial transaction data. Exemplary electronic transactions can be executed to send, receive, or transfer money, adjust investment allocations, apply for loans or credit lines, etc.

The virtual transaction system described herein can be deployed in various configurations. In some examples, the virtualization system and transaction system may represent separate systems that are stored on separate servers and/or maintained by separate entities. In this scenario, one entity may be the provider of the virtualization system and a separate entity may be the provider of the transaction system, and these systems can be configured to communicate with each other over a network using one or more application programing interfaces (APIs). In other examples, the virtualization system and the transaction system can be provided by a single entity that operates or manages both systems. In this scenario, both the virtualization system and the transaction system may be hosted by the same server system and/or may be communicate with each other via an intranet or internal network that that is maintained by the entity. Other deployment configurations also may be utilized.

In some embodiments, the virtual transaction platform can further include, or communicate with, an access control system that enforces access privileges on end-users participating a live 3D session hosted by the virtualization system. The access control system adds a security layer to the 3D environments to prevent unauthorized access to the transaction data stored by the transaction system and/or ensures that electronic transactions are only initiated or executed by authorized end-users. Enforcing appropriate access privileges on the end-user participants can be particularly important in scenarios where the transaction data comprises sensitive information (e.g., such as financial information or personal identifiable information). Further details of the access control system are discussed below.

The technologies described herein provide a variety of benefits and advantages. Amongst other things, the virtual transaction system facilitates collaborations and/or interactions in a 3D virtual environment in a manner that is similar to real-world or in-person interactions and without requiring end-users to purchase expensive immersive technology equipment. Additionally, in contrast to traditional remote collaboration systems, the transaction data associated with an end-user (e.g., client end-user) can be visualized or displayed directly within the virtual environment and does not need to be conveyed using screen sharing functions or by transmitting the transaction data via separate applications (e.g., such as email applications or cloud storage applications). Similarly, one or more of the end-users can access functionalities directly within the virtual environment (in some cases, functionalities that are integrated with the infographics) to initiate or execute electronic transactions (again, without having to open or use separate applications).

The technologies discussed herein can be used in a variety of different contexts and environments. One useful application of these technologies is in the context of providing a 3D virtual environment that permits collaboration and execution of electronic transactions in connection with providing banking or financial services. Another useful application is in the context of providing a 3D virtual environment that permits collaboration and execution of electronic transactions in connection with providing healthcare services. Another useful application is in the context of providing a 3D virtual environment that permits collaboration and execution of electronic transactions in connection with providing real estate or mortgage services. Another useful application is in the context of providing a 3D virtual environment that permits collaboration and execution of electronic transactions in connection with providing education services. While certain examples in disclosure describe embodiments where these technologies are applied to banking or financial services, it will be evident that the technologies described herein can be applied across many other contexts and environments as well.

In some embodiments, a computerized method is provided for facilitating collaboration and presentation of transaction data in a virtual environment. The method comprises: receiving, by a virtualization system, a first connection request over a network from a first client device operated by a client end-user; receiving, by the virtualization system, first image data over the network from the first client device corresponding to the client end-user; receiving, by a virtualization system, a second connection request over the network from a second client device operated by a platform end-user; receiving, by the virtualization system, second image data over the network from the second client device corresponding to the platform end-user; accessing, by the virtualization system, transaction data corresponding to the client end-user; generating, by a three-dimensional (3D) engine associated with the virtualization system, a 3D virtual environment in which the client end-user and platform end-user can collaborate in connection with the with the transaction data, wherein generating the 3D virtual environment includes: (i) generating, by the 3D engine, a first virtual user representation corresponding to the client end-user based, at least in part, on the first image data; (ii) generating, by the 3D engine, a second virtual user representation corresponding to the platform end-user based, at least in part, on the second image data; (iii) generating, by the 3D engine, one or more transactional infographics based, at least in part, on the transaction data; and (iv) incorporating the first virtual user representation, the second virtual user representation, and the one or more transactional infographics into the 3D virtual environment; and providing the first client device and the second client device with access to the 3D virtual environment over the network.

In certain embodiments, a system comprises one or more processing devices and one or more non-transitory memory devices for storing instructions, and execution of the instructions by the one or more processing devices causes the one or more computing devices to perform the aforementioned method.

In certain embodiments, the virtualization system can be configured to initiate or execute an electronic transaction in response to one or more interactions within the 3D virtual environment.

In certain embodiments, the virtualization system is in communication with a transaction system that stores the transaction data corresponding to the client end-user, the transaction system comprises an application programming interface (API), and the virtualization system communicates with the transaction system via the API to access the transaction data corresponding to the client end-user and to initiate or execute the electronic transaction.

In certain embodiments, the one or more transactional infographics are configured to present one or more data visualizations associated with the transaction data within the 3D virtual environment, the one or more data visualizations each include one or more objects or multimedia content, and generating the one or more data visualizations comprises customizing the one or more objects or the multimedia content, at least in part, using the transaction data.

In certain embodiments, the one or more transactional infographics are configured to present an asset data visualization, and generating the asset data visualization comprises configuring the one or more objects or the multimedia content to present a summary of the transaction data within the 3D virtual environment.

In certain embodiments, the one or more transactional infographics are configured to present a performance data visualization, and generating the performance data visualization comprises integrating historical asset data into the one or more objects or the multimedia content presented within the 3D virtual environment.

In certain embodiments, the one or more transactional infographics are configured to present a recommendation data visualization, and generating the recommendation data visualization comprises configuring the one or more objects or the multimedia content to present recommendations specified by the platform end-user within the 3D virtual environment.

In certain embodiments, the one or more transactional infographics are configured to present a projection data visualization and a risk data visualization, and generating the projection data visualization and the risk data visualization comprises integrating asset analytics data into the one or more objects or the multimedia content presented within the 3D virtual environment.

In certain embodiments, an access control system associated with the virtualization system is configured to assign access privileges to each end-user that accesses the 3D virtual environment, including the client end-user and the platform end-user.

In certain embodiments, the access privileges control permissions of the client end-user and the platform end-user within the 3D virtual environment, including permissions related to viewing or accessing the transaction data within the 3D virtual environment and permissions related to initiating or executing electronics within the 3D virtual environment.

In certain embodiments, the 3D engine is configured to execute generative artificial intelligence (AI) functions to generate the first virtual user representation, the second virtual user representation, the one or more transactional infographics, or a virtual scene for the 3D virtual environment.

It should be understood that the various individual aspects and features of the present invention described herein can be combined with any one or more individual aspect or feature, in any number, to form embodiments of the present invention that are specifically contemplated and encompassed by the present invention. Furthermore, any of the features recited in the claims can be combined with any of the other features recited in the claims, in any number or in any combination thereof. Such combinations are also expressly contemplated as being encompassed by the present invention.

Moreover, any of the embodiments described herein may be hardware-based, may be software-based, or, preferably, may comprise a mixture of both hardware and software elements. Thus, while the description herein may describe certain embodiments, features, or components as being implemented in software or hardware, it should be recognized that any embodiment, feature and/or component referenced in this disclosure can be implemented in hardware and/or software

Computer-readable media having stored thereon instructions configured to cause one or more computers to perform any of the methods described herein are also described.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below, and particularly pointed out in the claims filed with the application. Such combinations have advantages not specifically recited in the above summary. Other features and advantages will be apparent from the accompanying drawings and from the detailed description that follows below.

### BRIEF DESCRIPTION OF DRAWINGS

Specific features, aspects and advantages of the present disclosure will be better understood with regard to the following description and accompanying drawings, where:

FIG. 1A is a diagram of an exemplary virtual transaction platform for facilitating user collaboration and initiating electronic transactions in 3D virtual environments in accordance with certain embodiments;

FIG. 1B is a diagram illustrating an exemplary deployment configuration for the virtual transaction platform in accordance with certain embodiments;

FIG. 1C is a diagram illustrating another exemplary deployment configuration for the virtual transaction platform in accordance with certain embodiments;

FIG. 2 is a diagram illustrating details of an exemplary 3D engine according to certain embodiments;

FIG. 3 is a block diagram illustrating features of an exemplary transactional infographic according to certain embodiments;

FIG. 4 is a block diagram illustrating categories of transaction data according to certain embodiments;

FIG. 5A is an illustration of an exemplary virtual session in a 3D virtual environment according to certain embodiments;

FIG. 5B is another illustration of an exemplary virtual session in a 3D virtual environment according to certain embodiments;

FIG. 5C is another illustration of an exemplary virtual session in a 3D virtual environment according to certain embodiments;

FIG. 5D is another illustration of an exemplary virtual session in a 3D virtual environment according to certain embodiments;

FIG. 5E is another illustration of an exemplary virtual session in a 3D virtual environment according to certain embodiments;

FIG. 5F is another illustration of an exemplary virtual session in a 3D virtual environment according to certain embodiments;

FIG. 5G is another illustration of an exemplary virtual session in a 3D virtual environment according to certain embodiments;

FIG. 5H is another illustration of an exemplary virtual session in a 3D virtual environment according to certain embodiments;

FIG. 6A is a flow diagram illustrating an exemplary process flow that may be executed to provide a client end-user with access to a 3D virtual environment according to certain embodiments;

FIG. 6B is a flow diagram illustrating an exemplary process flow that may be executed to provide an invited end-user with access to a 3D virtual environment according to certain embodiments;

FIG. 6C is a flow diagram illustrating an exemplary process flow that may be executed to provide a platform end-user with access to a 3D virtual environment according to certain embodiments; and

FIG. 7 is a flowchart illustrating an exemplary method according to certain embodiments.

### DETAILED DESCRIPTION

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

The terms “left,” “right,” “front,” “rear,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

As used herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Certain data or functions may be described as “real-time,” “near real-time,” or “substantially real-time” within this disclosure. Any of these terms can refer to data or functions that are processed with a humanly imperceptible delay or minimal humanly perceptible delay. Alternatively, these terms can refer to data or functions that are processed within a specific time interval (e.g., in the order of milliseconds).

In the following description, reference is made to drawings which show by way of illustration various embodiments. Also, various embodiments will be described below by referring to several examples. It is to be understood that the embodiments may include changes in design and structure without departing from the scope of the claimed subject matter.

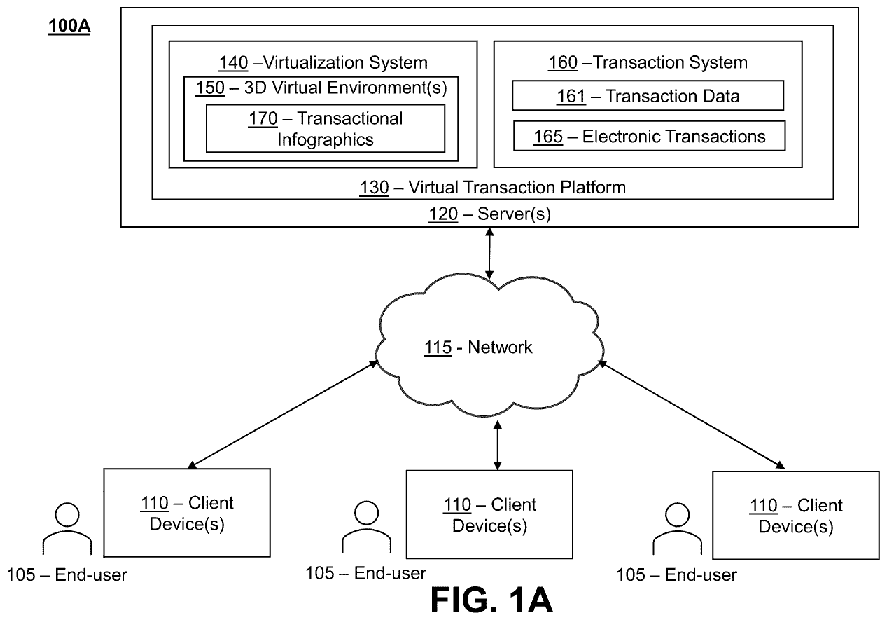

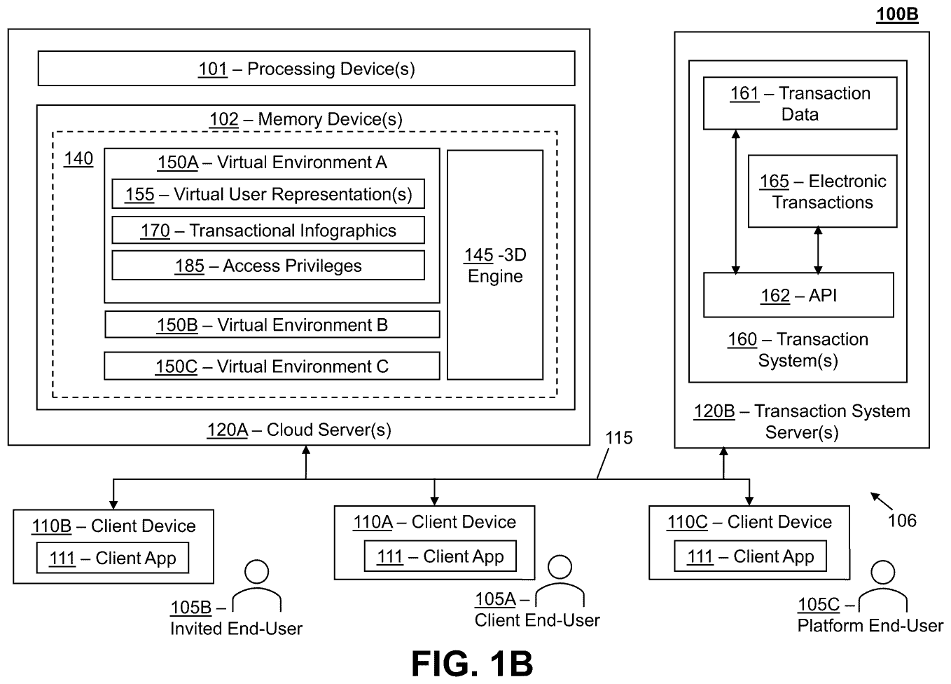

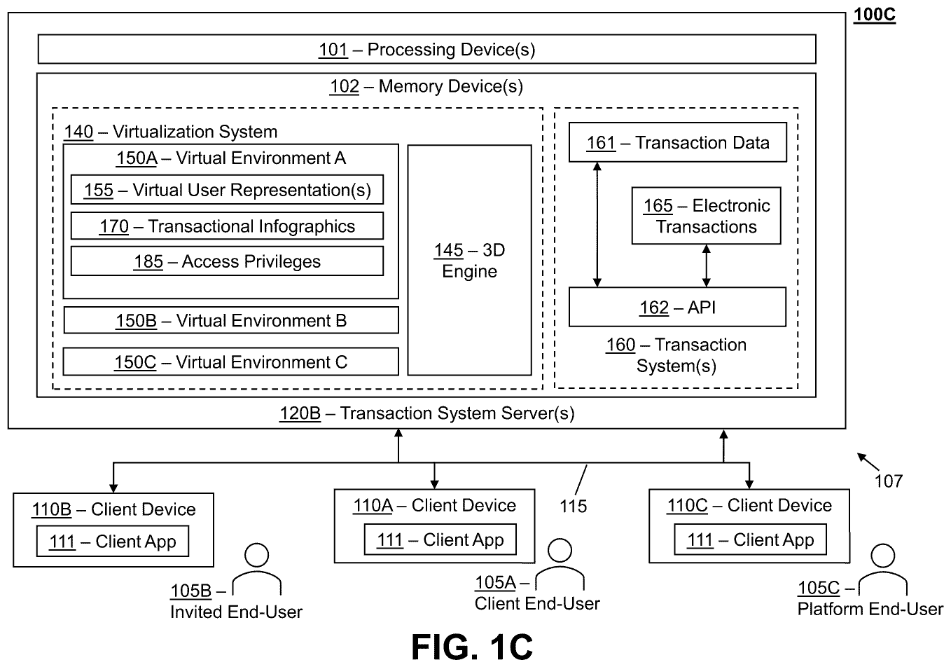

FIG. 1A is a diagram of an exemplary system 100A in accordance with certain embodiments. FIG. 1B is a diagram of an exemplary system 100B arranged in a first deployment configuration in accordance with certain embodiments. FIG. 1C is a diagram of an exemplary system 100C arranged in a second deployment configuration in accordance with certain embodiments. FIGS. 1A-1C are jointly discussed below.

The system (100A, 100B, 100C) comprises one or more client devices 110 (which, in some cases, can include client devices 110A, 110B, and 110C) and one or more servers 120 (which, in some cases, can include cloud servers 120A and/or transaction system servers 120B) that are in communication over a network 115. A virtual transaction platform 130 is stored on, and executed by, the one or more servers 120. The network 115 may represent any type of communication network, e.g., such as one that comprises a local area network (e.g., a Wi-Fi network), a personal area network (e.g., a Bluetooth network), a wide area network, an intranet, the Internet, a cellular network, a television network, and/or other types of networks.

All the components illustrated in FIG. 1A-1C, including the client devices 110 (e.g., client devices 110A, 110B, and 110C), servers 120 (e.g., cloud servers 120A and transaction system servers 120B), and virtual transaction platform 130 can be configured to communicate directly with each other and/or over the network 115 via wired or wireless communication links, or a combination of the two. Each of the client devices 110, servers 120, and virtual transaction platform 130 can include one or more communication devices, one or more memory devices 102, and one or more processing devices 101 that are capable of executing computer program instructions.

The one or more processing devices 101 may include one or more central processing units (CPUs), one or more microprocessors, one or more microcontrollers, one or more controllers, one or more complex instruction set computing (CISC) microprocessors, one or more reduced instruction set computing (RISC) microprocessors, one or more very long instruction word (VLIW) microprocessors, one or more graphics processor units (GPU), one or more digital signal processors, one or more application specific integrated circuits (ASICs), and/or any other type of processor or processing circuit capable of performing desired functions. The one or more processing devices 101 can be configured to execute any computer program instructions that are stored or included on the one or more memory devices 102 including, but not limited to, instructions associated with executing functions associated with generating 3D virtual environments and conducting electronic transactions.

The one or more memory devices 102 may include (i) non-volatile memory, such as, for example, read only memory (ROM) and/or (ii) volatile memory, such as, for example, random access memory (RAM). The non-volatile memory may be removable and/or non-removable non-volatile memory. Meanwhile, RAM may include dynamic RAM (DRAM), static RAM (SRAM), etc. Further, ROM may include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In certain embodiments, the memory devices 102 may be physical, non-transitory mediums. The one or more memory devices 102 can store instructions associated with generating 3D virtual environments and conducting electronic transactions.

Each of the one or more communication devices can include wired and wireless communication devices and/or interfaces that enable communications using wired and/or wireless communication techniques. Wired and/or wireless communication can be implemented using any one or combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware can depend on the network topologies and/or protocols implemented. In certain embodiments, exemplary communication hardware can comprise wired communication hardware including, but not limited to, one or more data buses, one or more universal serial buses (USBs), one or more networking cables (e.g., one or more coaxial cables, optical fiber cables, twisted pair cables, and/or other cables). Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.). In certain embodiments, the one or more communication devices can include one or more transceiver devices, each of which includes a transmitter and a receiver for communicating wirelessly. The one or more communication devices also can include one or more wired ports (e.g., Ethernet ports, USB ports, auxiliary ports, etc.) and related cables and wires (e.g., Ethernet cables, USB cables, auxiliary wires, etc.).

In certain embodiments, the one or more communication devices additionally, or alternatively, can include one or more modem devices, one or more router devices, one or more access points, and/or one or more mobile hot spots. For example, modem devices may enable the client devices 110, server(s) 120, and/or virtual transaction platform 130 to be connected to the Internet and/or other networks. The modem devices can permit bi-directional communication between the Internet (and/or other network) and the client devices 110, server(s) 120, and/or virtual transaction platform 130. In certain embodiments, one or more router devices and/or access points may enable the client devices 110, server(s) 120, and/or virtual transaction platform 130 to be connected to a LAN and/or other more other networks. In certain embodiments, one or more mobile hot spots may be configured to establish a LAN (e.g., a Wi-Fi network) that is linked to another network (e.g., a cellular network). The mobile hot spot may enable the client devices 110, server(s) 120, and/or virtual transaction platform 130 to access the Internet and/or other networks.

In certain embodiments, the client devices 110 (including client devices 110A, 110B, and 110C) may represent desktop computers, laptop computers, mobile devices (e.g., smart phones, personal digital assistants, tablet devices, vehicular computing devices, wearable devices, or any other device that is mobile in nature), and/or other types of devices. The one or more servers 120 (including cloud servers 120A and/or transaction system servers 120B) may generally represent any type of computing device, including any of the client devices 110 mentioned above. In some embodiments, the one or more servers 120 also can comprise one or more mainframe computing devices and/or one or more virtual servers that are executed in a cloud-computing environment. Additionally, in some embodiments, the one or more servers 120 can be configured to execute web servers and can communicate with the client devices 110 and/or other devices over the network 115 (e.g., over the Internet).

In certain embodiments, the virtual transaction platform 130 can be stored on, and executed by, the one or more servers 120. Additionally, or alternatively, the virtual transaction platform 130 can be stored on, and executed by, the one or more client devices 110. The virtual transaction platform 130 can be stored on, and executed, by other devices as well.

In some embodiments, the virtual transaction platform 130 (or certain components associated therewith) also can be stored as a local application (e.g., such as client application 111) on a client device 110, or integrated with a local application stored on a client device 110, to implement the techniques and functions described herein. In some instances, a client application 111 stored on a client device can include a mobile application, desktop application, and/or web browser.

In some embodiments, the functionalities performed by the virtual transaction platform 130 described herein can be implemented by one or more front-end applications executed on client devices 110 operated by end-users and one or more back-end applications executed on one or more servers 120. In this scenario, the client application 111 may serve as a front-end application that accesses one or more back-end applications stored on, and executed by, the one or more servers 120. Any functionality associated with the virtual transaction platform 130 described herein can be executed by either a front-end application or a back-end application, or jointly by both applications.

Regardless of its implementation, the virtual transaction platform 130 can include one or more virtualization systems 140 and one or more transaction systems 160. For purposes of simplicity, certain portions of this disclosure may describe the virtual transaction platform 130 as including a single virtualization system 140 and a single transaction system 160. However, it should be understood the virtual transaction platform 130 can include any number of virtualization systems 140 and any number of transaction systems 160.

As explained in further detail below, the virtualization system 140 can execute functions associated with generating 3D virtual environments 150 that simulate real-life settings in which end-users 105 can meet and interact with each other to discuss the transaction data 161 and/or initiate or execute various electronic transactions 165 on behalf of one or more end-user 105. In doing so, the virtualization system 140 may communicate with the transaction system 160 to access the transaction data 161, incorporate the transaction data 161 into transactional infographics 170 presented within the 3D virtual environments 150, and initiate or execute electronic transactions 165 related to the transaction data 161.

The transaction infographics 170 incorporated into the 3D virtual environments 150 can generally include any object or digital representation related to, or derived from, transaction data 161 obtained from the transaction system 160. The transaction infographics 170 can be presented in various formats or configurations. In some examples, a transaction infographic 170 can include one or more 2D objects, one or more 3D objects, one or more images, one or more graphics, one or more animations, one or more videos, and/or one or more textual strings that present transaction data 161 and/or information associated with the transaction data 161.

In some embodiments, the transaction infographics 170 can enable end-users to view, access, and/or manipulate transaction data 161 directly within 3D virtual environments 150. Additionally, the 3D virtual environments 150 can be configured with functionalities that enable electronic transactions 165 to be initiated or executed based on interactions with the transaction infographics 170 and/or other features presented in the environments. Integration of these and other functionalities into the 3D virtual environments 150 can enhance the collaboration and realism associated with virtual meetings, and avoids the need access or launch separate applications during the virtual meetings (e.g., separate applications that provide access to an end-user's transaction data 161 and/or enable electronic transactions 165 to be conducted).

The components of the virtual transaction platform 130, including the virtualization system 140 and transaction system 160, can be arranged in various deployment configurations to implement the aforementioned functionalities and other functionalities described herein. FIGS. 1B and 1C illustrate two exemplary deployment configurations for virtual transaction platform 130.

FIG. 1B illustrates a first deployment configuration 106 in which the virtualization system 140 and transaction system 160 are stored or hosted on separate server systems that communicate with each other over a network 115. In this example, the virtualization system 140 is stored on, and executed by, one or more cloud servers 120A and the transaction system 160 is stored on one or more transaction system servers 120B. In some embodiments, the one or more cloud servers 120A can include one or more virtual servers that are hosted in a cloud computing environment, which can include a scalable infrastructure that dynamically adapts to workload and provisioning requirements associated with hosting or providing 3D virtual environments 150 to end-users 105. The one or more transaction system servers 120B can include one or more web servers, one or more virtual servers, and/or one or more hardware servers (e.g., mainframe servers) that are configured to store, host, and provide access to transaction data 161 and functionalities associated with executing electronic transactions 165.

The deployment configuration 106 illustrated in FIG. 1B can be beneficial in scenarios where the virtualization system 140 and transaction system 160 are maintained, hosted, or provided by separate entities. For example, in some cases, the transaction system 160 may correspond to an electronic or web-based platform provided by a banking or financial services institution, and the virtualization system 140 may correspond to a SaaS provider or electronic services provider that offers virtualization services to a plurality of institutions. In some exemplary scenarios, the virtualization system 140 can host or provide 3D virtual environments 150 in which clients or customers (e.g., client end-user 105A) of the banking institution or financial services institution can engage and collaborate with representatives or financial specialists (e.g., platform end-users 105B) associated with the banking or financial services institution. To enhance collaboration during the 3D virtual environments 150, the virtualization system 140 can communicate with transaction system 160 over a network 115 (e.g., the Internet) through one or more application programming interfaces (APIs) 162 to integrate the transaction data 161 into the 3D virtual environments 150 and configure the 3D virtual environments 150 with functionalities for initiating or executing electronic transactions 165.

FIG. 1C illustrates a second deployment configuration 107 in which the virtualization system 140 and transaction system 160 are stored on the same server system and/or hosted or maintained by a single entity. In this example, the virtualization system 140 and transaction system 160 are illustrated as being stored on one or more transaction system servers 120B. In other examples, the virtualization system 140 and transaction system 160 also can be stored in the same cloud environment, such as on one or more cloud servers 120A (e.g., FIG. 1B).

The deployment configuration 107 can be beneficial in scenarios where a single entity is responsible for maintaining or managing both the virtualization system 140 and transaction system 160. In some examples, a banking or financial services institution that stores and manages transaction data 161 for end-users also may store or host the virtualization system 140 to provide clients or customers (e.g., client end-users 105A) and the institution's representatives (e.g., platform end-users 105b) with 3D virtual environments 150 in which they can collaborate in connection with banking or financial services. In this scenario, the virtualization system 140 may communicate with the transaction system 160 over an internal network 115 (e.g., an intranet or private network associated with the institution) to access the transaction data 161 for customers and/or execute electronic transactions 165.

The components of the virtual transaction platform 130, including the virtualization system 140 and transaction system 160, can be arranged in a variety of other deployment configurations as well.

As illustrated in FIGS. 1B-1C, the virtualization system 140 can create, manage, and host a plurality of 3D virtual environments 150 (such as virtual environment 150A, virtual environment 150B, and environment 150C). Each of the virtual environments 150 can correspond to a virtual session that is created or initialized by the virtualization system 140 is response to an end-user 105 submitting a request for a virtual session.

The types of functionalities or services provided by the transaction system 160 can vary. In certain embodiments, the transaction system 160 can represent an electronic system that stores transaction data 161 for end-users 105 (e.g., client end-users 105A) and executes electronic transactions 165 relating to the transaction data 161. In some examples, the transaction system 160 can represent an electronic banking system, an electronic financial services system, an electronic wealth management system, and/or similar type of system. In these embodiments, the transaction system 160 may store, manage, and provide access to transaction data 161 pertaining to financials, assets, and/or wealth-related data for each of a plurality of end-users 105 (e.g., client end-users 105A). The categories or types of transaction data 161 can vary depending upon the products and/or services managed by the transaction system 160.

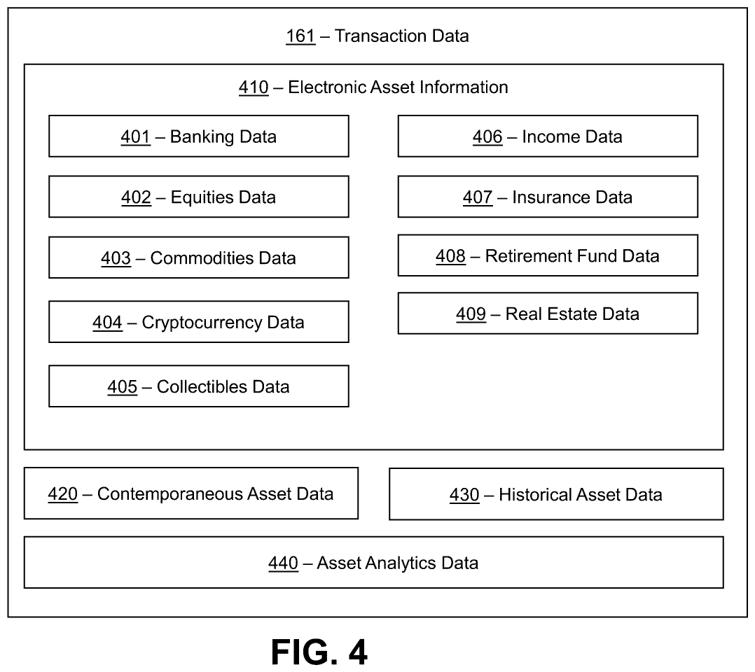

FIG. 4 is a block diagram illustrating exemplary types or categories of transaction data 161 that can be stored and managed by the transaction system 160 according to certain embodiments. For each end-user 105, the transaction data 161 can comprise various types of electronic asset information 410 related to the end-user's financials, assets, or wealth. In some examples, the transaction data 161 and/or electronic asset information 410 can include one or more of the following: banking data 401 (e.g., indicating personal checking or savings accounts and/or business banking accounts owned by the end-user); equities data 402 (e.g., indicating the end-user's investments in stocks, bonds, fiat currencies, mutual funds, etc.); commodities data 403 (e.g., indicating the end-user's investments in agriculture, energies, metals, soft commodities, etc.); cryptocurrency data 404 (e.g., indicating the end-user's investments in cryptocurrencies, virtual currencies, altcoins, blockchains, etc.); collectibles data 405 (e.g., indicating the end-user's investments in art, rare coins, antiques, etc.); income data 406 (e.g., indicating the end-user's income and/or sources of revenue); insurance data 407 (e.g., indicating life insurance and/or other types of insurance policies owned by the end-user); retirement fund data 408 (e.g., indicating the end-user's individual retirement accounts or IRAs, 401ks, pensions, etc.); and/or real estate data 409 (e.g., indicating the end-user's investments in residential properties, commercial properties, etc.). The transaction system 160 can store many other types of transaction data 161 related to the financials, assets, or wealth of each end-user 105.

For each end-user 105 (e.g., each client end-user 105A), the transaction system 160 may store, manage, track, and/or monitor the end-user's banking data 401, equities data 402, commodities data 403, cryptocurrency data 404, collectibles data 405, income data 406, insurance data 407, retirement fund data 408, real estate data 409, and/or other electronic asset information 410. At any given point in time, transaction system 160 can be accessed to provide contemporaneous asset data 420 indicating a current status or state of the end-user's transaction data 161 and/or electronic asset information 410. Additionally, the transaction system 160 can be accessed to obtain historical asset data 430 indicating previous states or statuses of transaction data 161 and/or electronic asset information 410 associated with the end-user 105 and/or previous transactions associated with the transaction data 161 and/or electronic asset information 410 of the end-user 105.

For each end-user 105, the transaction system 160 also may generate and store asset analytics data 430 derived from, or associated with, the end-user's transaction data 161 and/or electronic asset information 410. The asset analytics data 430 can be generated using various analysis, assessment, and/or analytic functions, and can comprise various insights relating to the end-user's transaction data 161 and/or electronic asset information 410. In some examples, the asset analytics data 430 can comprise future projections or predictions, risk assessments, historical performance analyses, reallocation strategies, and/or recommendations pertaining to the end-user's transaction data 161 and/or electronic asset information 410.

Returning to FIGS. 1A-1C, in addition to storing the transaction data 161 associated with end-users 105, the transaction system 160 can enable end-users 105 (e.g., client end-users 105A and/or platform users 105B) to execute various types of electronic transactions 165 relating to the transaction data 161. In some non-limiting examples, the electronic transactions 165 can include one or more of the following: depositing, transferring, and/or withdrawing funds in bank accounts; initiating or sending electronic wire transfers; purchasing, selling and/or trading equities; adjusting allocations of assets; buying, selling, and/or trading cryptocurrencies or virtual currencies; buying, selling, and/or trading commodities; buying, selling, and/or trading collectibles; buying, selling, and/or modifying insurance products; depositing and/or withdrawing funds from retirement accounts; buying, selling, and/or leasing real estate; extending credit and/or loans to end-users (or processing applications associated with credit or loans); and/or adjusting income received from one or more income sources. Many other types of electronic transactions 165 also can be executed by the transaction system 160 in addition to those mentioned above.

The virtualization system 140 can execute various functions related to generating 3D virtual environments 150 that can be accessed by end-users 105 operating client devices 110. The 3D virtual environments 150 generated by the virtualization system 140 facilitate interactions and collaboration among remotely situated end-users 105 (e.g., client end-users 105A, platform end-users 105B, and/or invited end-users 105C) in a 3D setting that is akin to real-world or in-person meetings. The transaction data 161 of one or more end-users 105 can be accessed and presented in these virtual settings, and the end-users can discuss, interact, and/or collaborate to review and/or modify the transaction data 161. Additionally, in some embodiments, the end-users 105 can initiate or execute electronic transactions 165 directly within the 3D virtual environments 150.

In certain embodiments, the virtualization system 140 includes a 3D engine 145 that is configured to generate the 3D virtual environments 150 and/or content included the 3D virtual environments. The 3D engine 145 can be configured to insert and display virtual representations 155 of each end-user participant in a 3D virtual environment 150, as well as transactional infographics 170 related to the transaction data 161 for one or more the end-user participants. Amongst other things, the transactional infographics 170 presented in the 3D virtual environment 150 can visualize the transaction data 1061 for one or more the end-user participants and present various types of analytics related to the transaction data 161 (e.g., such as risk analysis information, projections, predictions, and/or recommendations related to the transaction data 161. Additionally, the transactional infographics 170 (or other interactive features presented with the 3D virtual environments) can be utilized to initiate or execute electronic transactions 165 directly within a 3D virtual environment 150.

Various types of end-users 105 can join or access 3D virtual environment sessions generated or offered by the virtualization system 140, including client end-users 105A, platform end-users 105, and invited end-users 105C. The client end-users 105A may correspond to end-users 105 who are customers or clients of the transaction system 160, and the client end-users 105 may utilize client devices 110A to access the virtual transaction platform 130 or components thereof. In some examples, the client end-users 105A may represent customers of a banking or financial services provider. The platform end-users 105B may correspond to end-users 105 who are representatives or service providers affiliated with the transaction system 160, and the platform end-users 105B may utilize client devices 110B to access the virtual transaction platform 130 or components thereof. In some examples, the platform end-users 105B may represent end-users 105 that provide financial advising, wealth management, and/or banking services. The invited end-users 105C may correspond to end-users 105 who are invited by either a client end-user 105A or platform end-user 105B to join 3D a virtual session hosted by the virtualization system 140, and the invited end-users 105C may utilize client devices 110C to access the virtual transaction platform 130 or components thereof. In some examples, an invited end-user 105C may represent a friend or family member of a client end-user 105C. In other examples, an invited end-user 105C may represent to counterparty to a transaction involving a client end-user 105A and the invited end-user 105C.

In some exemplary scenarios, the virtualization system 140 and/or 3D engine 145 is configured to generate a live virtual session which enables a client end-user 105A to virtually access his or her transaction data 161 stored by the transaction system 160 and the virtual session is hosted in a 3D virtual environment 150 generated by the virtualization system 140. The 3D engine 145 can generate a virtual scene for the 3D virtual environment, and insert a virtual user representation 155 corresponding to the client end-user 105A into the virtual scene. Additionally, the 3D engine 145 can generate and insert one or more transactional infographics 170 into the virtual scene, which visually illustrate client end-user's transaction data 161 and/or analytics related to the transaction data 161. In some examples, the transactional infographics 170 can be generated and/or customized using the electronic asset information 410, contemporaneous status data 420, historical asset data 430, and/or asset analytics data 440 stored on the transaction system 160.

Staying with the above example, one or more platform end-users 105B also may join the live 3D virtual session to discuss the transaction data 161 and/or provide advice or recommendations to the client end-user 105A, and the 3D engine 145 may insert a separate virtual user representation 155 for each platform end-user 105B into the virtual scene. Before or during a live 3D virtual session, a client end-user 105A and/or a platform end-user 105B may wish to invite or more third parties to join the live 3D virtual session. In some examples, a client end-user 105A may wish to invite a spouse, child, parent, or friend to join the session and participate in discussions relating to the transaction data 161. In other examples, a platform end-user 105B may wish to invite a counterparty to a transaction or agreement to attend a 3D live session. When it is desired to add another party to the session, an electronic invite can be sent to the party and, upon acceptance, the party can join the session as an invited end-user 105C. The 3D engine 145 may insert a separate virtual user representation 155 for each invited end-user 105C into the virtual scene.

During the virtual session, the end-users 105 (e.g., client end-users 105A, platform end-user 105B, and invited end-users 105C) can interact and collaborate within the 3D environment 150 generated by the virtualization system 140. In some examples, a platform end-user 105B may utilize one or more transactional infographics 170 presented within the 3D virtual environment 150 to explain or review a current state of the transaction data 161 for a client end-user 105A and/or to visually illustrate risk exposures, projections, recommendations, and/or analytics related to the transaction data 161. In some instances, the client end-user 105A and/or one of the platform end-users 105B may initiate or execute one or more electronic transactions 165 based on the collaboration during the session.

In certain embodiments, each of the aforementioned end-users 105 (e.g., client end-users 105A, platform end-users 105B, and invited end-users 105C) may be associated with access privileges 185 that define their rights, privileges, and/or permissions in the 3D virtual environments 150. Amongst other things, the access privileges 185 associated with an end-user 105 can define the end-user's rights, privileges, or permissions to access the transaction data 161, initiate or execute electronic transactions 165, and/or control or manipulate the transactional infographics 170 presented in the 3D virtual environment 150.

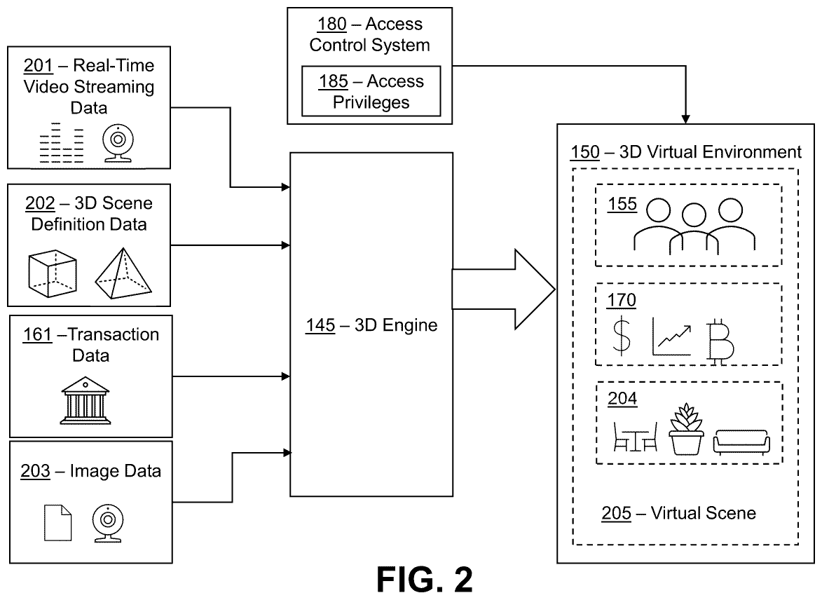

FIG. 2 is a block diagram illustrating an exemplary technique for generating a 3D virtual environment 150 according to certain embodiments.

As described above, the 3D engine 145 can be stored and/or hosted on one or more servers 120. In some embodiments, the 3D engine 145 can be stored or hosted on a server system that is separate from the transaction system 160 (e.g., one or more cloud servers 120A). In other embodiments, the 3D engine 145 can be stored or hosted on a server system affiliated with the transaction system 160 (e.g., one or more transaction system servers 120B).

In the example of FIG. 2, a 3D engine 145 generates a 3D virtual environment 150 using a plurality of data sources, including real-time video streaming data 201, 3D scene definition data 202, transaction data 161, and image data 203. In certain embodiments, the 3D virtual environment 150 may comprise a virtual scene 205 corresponding to a virtual room or setting that simulates a real-world room or setting in three-dimensional virtual space. The three-dimensional space may be defined using a Cartesian coordinate system that comprises three axes (an x-axis, y-axis, and z-axis), and various types of objects can be inserted at locations defined by 3D reference points within the three-dimensional space. Exemplary objects inserted into the virtual scene 205 within the 3D virtual environment 150 can include virtual user representations 155, transactional infographics 170, and background objects 204.

The 3D engine 145 can be configured with generative capabilities that enable the 3D engine 145 to receive or ingest data from a plurality of sources (e.g., including real-time video streaming data 201, 3D scene definition data 202, transaction data 161, and image data 203) and utilize this data to generate or create the 3D virtual environment 150 and/or content included in the 3D virtual environment (e.g., content including the virtual scene 205, virtual user representations 155, transactional infographics 170, and/or background objects 204). The 3D engine 145 can generate the content using various types of generative functionalities and capabilities.

In some embodiments, the 3D engine 145 can be configured with generative artificial intelligence (AI) capabilities that enable the 3D engine to generate some or all of the content for the 3D virtual environments 150. For example, the 3D engine 145 can include one or more generative AI models that are trained to generate the virtual scene 205, virtual user representations 155, transactional infographics 170, background objects 204, and/or other content associated with the virtual environments 150. In certain embodiments, the one or more generative AI models are adapted to generate the content by applying transformations on data received from one or more sources (e.g., by applying transformations on the real-time video streaming data 201, 3D scene definition data 202, transaction data 161, and image data 203). In some examples, the one or more generative AI models can include one or more GANs (generative adversarial networks), one or more VAEs (variational autoencoders), one or more neural rendering models, and/or other models capable of generating 3D and/or 2D content. Additionally, the one or more generative AI models can be trained to execute various types of generative tasks and/or computer vision tasks to assist the models with generating the content for the 3D virtual environments 150. In some examples, the one or more generative models can be trained to execute scene synthesis tasks, viewpoint synthesis tasks, 3D and 2D object generation tasks, object reconstruction tasks, neural rendering tasks, image-to-image translation tasks, domain translation tasks, object detection tasks, object classification tasks, segmentation tasks, and/or other types of generative or computer vision tasks.

Additionally, or alternatively, the 3D engine 145 can be configured with procedural generative capabilities that enable the 3D engine to generate some or all of the content for the 3D virtual environments 150. For example, the 3D engine 145 can store and/or execute one or more procedural generative functions that are configured to generate the virtual scene 205, virtual user representations 155, transactional infographics 170, background objects 204, and/or other content associated with the virtual environments 150. In some examples, the procedural generative functions can be configured to algorithmically generate or create some or all of the content using a set of stored rules, procedures, or the like. Additionally, in some configurations, the procedural generative functions can modify, customize, or create variations of content by adjusting pre-defined parameters or algorithms associated with defining the content.

Additionally, or alternatively, the 3D engine 145 can access and utilize pre-stored objects (e.g., 2D or 3D objects) to generate some or all of the content for the 3D virtual environments 150. In some examples, the 3D engine 145 can store or access a database of premade objects to generate the virtual scene 205, virtual user representations 155, transactional infographics 170, background objects 204, and/or other content associated with the virtual environments 150.

The 3D engine 145 can generate the content for the 3D virtual environments 150 using any combination of the techniques described above and/or using other techniques.

In certain embodiments, the 3D engine 145 can receive, access and/or store 3D scene definition data 202 that is utilized to generate a setting associated with the virtual scene 205. In some examples, the 3D scene definition data 202 can include data that defines the dimensions of a virtual room to be output as part of the virtual scene 205 (e.g., dimensions of the walls, floor, ceiling, etc.). The 3D scene definition data 202 also can include object information that defines one or more background objects 204 to be inserted into the virtual scene 205 (e.g., objects corresponding to chairs, couches, tables, plants, and other objects to be displayed in the virtual scene 205). The 3D engine 145 can process the 3D scene definition data 202 to generate and/or render the virtual scene 205 and insert the background objects 204 into the virtual scene 205 at desired locations.

The 3D engine 145 also can receive, access, and/or store real-time video streaming data 201 and/or image data 203 to generate virtual user representations 155 corresponding to each of the end-users 105 participating in the virtual session, and insert the virtual user representations 155 into the virtual scene 205. The manner in which the virtual user representations 155 are generated can vary.

In some instances, a client device 110 (such as client device 110A, 110B, or 110C) operated by an end-user participant can include, or communicate with, a camera that generates real-time video streaming data 201. The real-time video streaming data 201 can include a live video feed capturing images of the end-user participant, and the client device 110 transmits the real-time video streaming data 201 over a network 115 to the virtualization system 140. Upon receiving the real-time video streaming data 201, the 3D engine 145 can generate a virtual user representation 155 corresponding to the end-user participant (e.g., using generative AI models and/or procedural generative functions).

In some examples, the virtualization system 140 and/or 3D engine 140 executes segmentation functions (and/or other computer vision functions) on the real-time video streaming data 201 to extract image content depicting the end-user participant from images included in the video streaming data 201 and/or to remove background content from the real-time video streaming data 201. The extracted content can then be utilized to generate a dynamic virtual user representation 155 that is updated in real-time based on changes captured in the real-time video streaming data 201. The dynamic virtual user representation 155 inserted into the virtual scene 205 can include a 2D or 3D cutout of the live imaging feed that depicts the end-user participant.

A dynamic virtual user representation 155 can be inserted into the virtual scene 205 for each end-user participant that provides access to a local camera device and/or access to real-time video streaming data 201. In some scenarios, an end-user participant may not have access to a camera and/or may not which to participate in the 3D virtual session via a live video feed. In these scenarios, the 3D engine 145 may receive, access and/or store image data 203 that can be used to generate a virtual user representation 155 for the end-user participant. The image data 203 may include a static 2D image or object, such as a profile picture or avatar, corresponding to the end-user participant. The 3D engine 145 can utilize the image data 203 to render a static or less dynamic virtual representation 155 for the end-user participant in the virtual scene 205.

The 3D engine 145 also can receive and/or access transaction data 161 for one or more end-user participants (e.g., one or more client end-users 105A) from one or more transaction systems 160 in communication with the virtualization system 160. The 3D engine 145 can utilize the transaction data 161 to generate one or more transactional infographics 170 for the virtual scene 205 (e.g., using generative AI models, procedural generative functions, and/or prestored objects).

In certain embodiments, each transactional infographic 170 may include one or more objects that can be customized using the transaction data 161. In some examples, the 3D engine 145 can generate and/or render a transactional infographic 170 in the virtual scene that presents or visualizes a summary of electronic asset information 410 for a client end-user 105A participating in the session. In other examples, the 3D engine 145 can generate and/or render a transactional infographic 170 in the virtual scene 205 which presents or visualizes the asset analytics data 440 for the client end-user 105A. In further examples, the 3D engine 145 can generate and/or render a transactional infographic 170 in the virtual scene that presents or visualizes the banking data 401, equities data 402, commodities data 403, cryptocurrency data 404, collectibles data 405, income data 406, insurance data 407, retirement fund data 408, real estate data 409 for the client end-user 105A.

Additionally, the transactional infographics 170 inserted into the virtual scene 205 (or other selectable options presented to end-users 105 on client devices 110) also can be configured with functionalities for initiating or executing various types of electronic transactions 165. For example, after a client end-user participant discusses their asset or financial information with a platform end-user participant, the client end-user participant may desire to purchase, sell, or trade assets, reallocate investments, transfer money, apply for credit lines, etc. These and other electronic transactions 165 can be initiated or executed directly in the 3D virtual environment 150 and/or can be initiated or executed based on discussions or interactions that occurred within the 3D virtual environment 150. In some cases, an end-user participant may select an interactive option inserted into the 3D virtual environment 150 and/or presented on a graphical user interface (GUI) that displays the 3D virtual environment 150 to initiate or execute one or more electronic transactions 165.

In many embodiments, it may be desired to incorporate security features into the 3D virtual environments 150 to ensure the security of the transaction data 161 associated with end-user participants, as well as any electronic transactions 165 that are initiated or executed on behalf of the end-user participants.

Along these lines, the virtual transaction platform 130, virtualization system 140 and/or the transaction system 160 may store an access control system 180 that manages, enforces, and/or provisions access privileges 185 to end-users 105 within the 3D virtual environments 150. The enforcement of the access privileges 185 on the end-users 105 can add a security layer to the 3D virtual environments 150 which prevents unauthorized access to the transaction data 161 and/or prevents unauthorized electronic transactions 165 from being initiated or executed. Managing or provisioning of appropriate access privileges 185 to each of the end-users 105 in the 3D virtual environments 150 can be particularly important in scenarios where the transaction system 160 stores and manages financial information, PII (personal identifiable information) information, and/or other types of types of sensitive information.

In some cases, the access privileges 185 can be delegated or provisioned to end-users 105 by the access control system 180 using roles assigned to the end-users 105. For example, a platform end-user 105B may be assigned a first role that provides broadest set of access privileges 185, and which enables the platform end-user 105B to access transaction data 161 for any client end-users 105A participating in a 3D virtual session and/or initiate or execute electronic transactions 165 on behalf of the client end-users 105A. A client-user 105A may be assigned a second role that enables the client-user 105A to access his or her own transaction data 161 and execute electronic transactions 165 relating to his or her own transaction data 161 (but which prohibits the client end-user 105A from accessing transaction data 161 of other client end-users 105A and/or prohibits the client end-user 105A from initiating or executing electronic transactions on behalf of other client end-users 105A). An invited end-user 105C may be assigned a third role that has the most restrictive privileges. For example, in some cases, an invited end-user 105C may only be able to view a subset of transaction data 181 for which authorization is granted by a client end-user 105A or platform end-user 105B. Likewise, an invited end-user 105C may be prohibited from initiating or executing electronic transactions 165 in the 3D virtual environments 150.

As mentioned above, the virtualization system 140 can be configured to generate transactional infographics 170 that visualize some or all of the transaction data 161 for one or more end-users 105 (e.g., one or more client end-users 105A) participating in live 3D session, and insert the transactional infographics 170 into the 3D virtual environment 150. In some configurations, the virtualization system 140 can communicate with the transaction system 160 (e.g., via API 162) to retrieve the transaction data 161 associated with a client end-user 105A and customize a transactional infographic 170 using the transaction data 161.

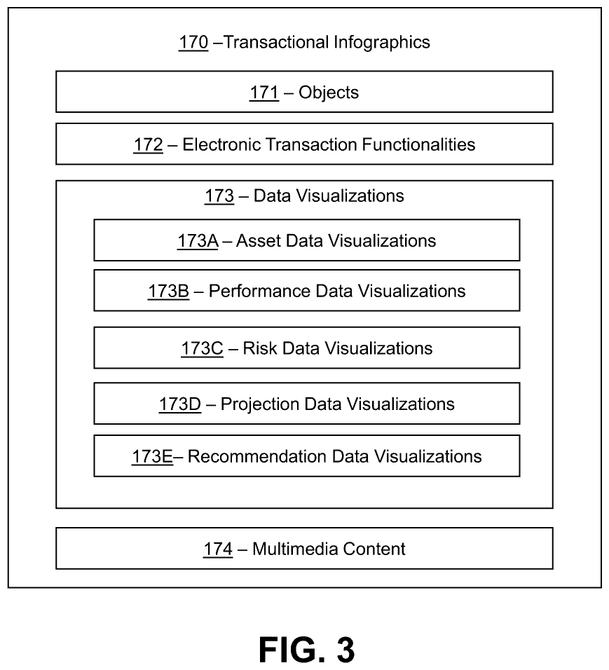

FIG. 3 illustrates exemplary features and functionalities associated with transactional infographics 170 according to certain embodiments.

In some examples, a transactional infographic 170 can include one or more objects 171. Each object 171 may correspond to a 2D object or a 3D object that is inserted within a three-dimensional virtual setting of a 3D virtual environment 150. In examples where a 3D virtual environment 150 is created to enable end-users 105 to discuss financial planning, the objects 171 can include digital representations that are used to illustrate assets or financial information. The appearance of these objects 171 can be customized or modified using the transaction data 161 of a client end-user 105A participating in the 3D virtual meeting (e.g., customized to depict the client's end-user's specific assets and investments, or analytics related to the client end-user's assets and investments).

A transactional infographic 170 may additionally, or alternatively, include multimedia content 174 including, but not limited to, textual content, audio content, graphics content, image content, video content, and/or animation content. In some examples, the multimedia content 174 can be configured or customized to present transaction data 161 (e.g., relating to assets or financial information) associated a client-end user 105A participating in the 3D virtual meeting.

In some embodiments, the transactional infographics 170 also can be configured with electronic transaction functionalities 172 that enable end-users 105 participating in the 3D meeting to initiate or execute various types of electronic transactions 165. These electronic transaction functionalities 172 can include code that is adapted to communicate with the transaction system 160 (e.g., via API 162) to initiate or execute the electronic transactions 165.

The end-users may interact with the transactional infographics 170 using various types of input mechanisms (e.g., mouse devices, keyboard devices, gesture recognition gloves or devices, etc.) provided by the client devices 110 operated by the end-users 105. These interactions with the transactional infographics 170 can initiate one or more electronic transaction functionalities 172. In some examples, the electronic transaction functionalities 172 can initiate or execute electronic transactions that are related to a client end-user's assets or financial information (e.g., such as electronic transactions 165 that involve money transfers, invoice payments, investment reallocations, purchasing or selling of equities, credit line request submissions, etc.).

Additionally, in some embodiments, the transactional infographics 170 can be configured in various states or configurations to present data visualizations 173 relating a client end-user's transaction data 161. Each data visualization 173 can utilize one or more objects 171 (e.g., one or more 2D objects and/or one or more 3D objects) and/or multimedia content 174 to convey or visualize details related to the transaction data 161. Additionally, some or all of the data visualizations 173 can include interactive or selectable options that enable electronic transaction functionalities 172 to be initiated or executed.

Exemplary data visualizations 173 can include, inter alia, asset data visualizations 173A, performance data visualizations 173B, risk data visualizations 173C, projection data visualizations 173D, and recommendation data visualizations 173E. An asset data visualization 173A can correspond to a configuration of a transactional infographic 170 that utilizes one or more objects 171 and/or multimedia content 174 to covey information or summaries relating to client end-user's assets or financial information. A performance data visualization 173B can correspond to a configuration of a transactional infographic 170 that utilizes one or more objects 171 and/or multimedia content 174 to covey historical performance analyses or data relating to client end-user's assets or financial information. A risk data visualization 173C can correspond to a configuration of a transactional infographic 170 that utilizes one or more objects 171 and/or multimedia content 174 to covey risks and/or exposure information relating to client end-user's assets or financial information. A projection data visualization 173D can correspond to a configuration of a transactional infographic 170 that utilizes one or more objects 171 and/or multimedia content 174 to covey projections, predictions, and/or trends relating to client end-user's assets or financial information. A recommendation data visualization 173E can correspond to a configuration of a transactional infographic 170 that utilizes one or more objects 171 and/or multimedia content 174 to convey investment advice, recommendations, suggestions, or guidance relating to client end-user's assets or financial information.

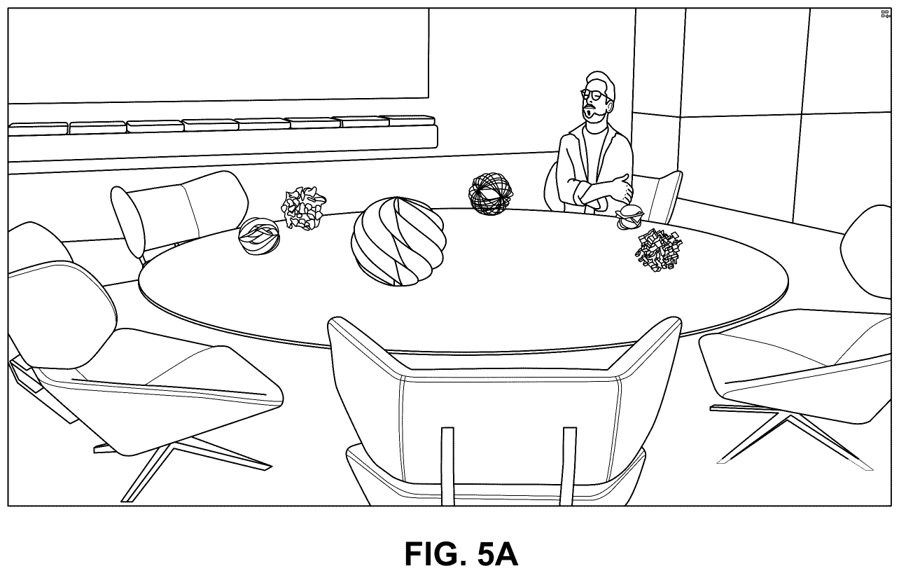

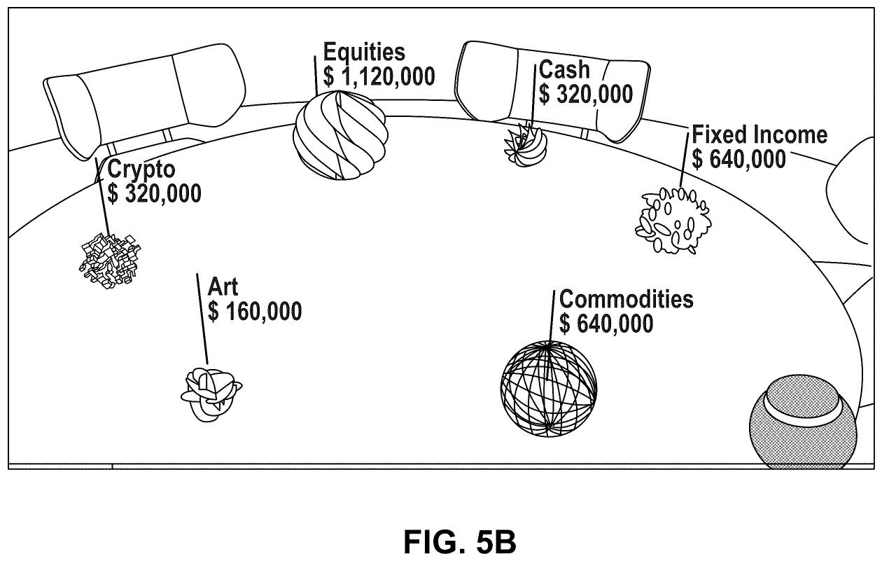

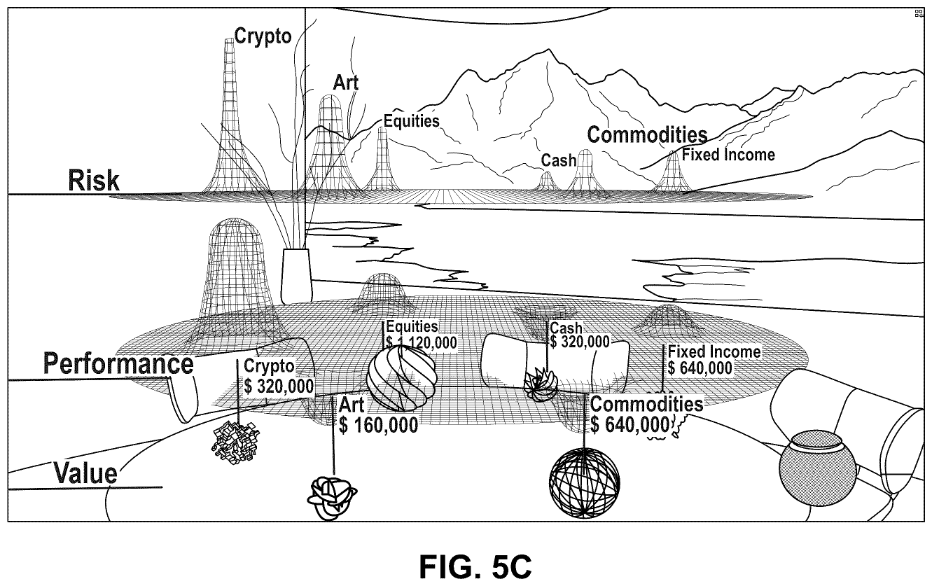

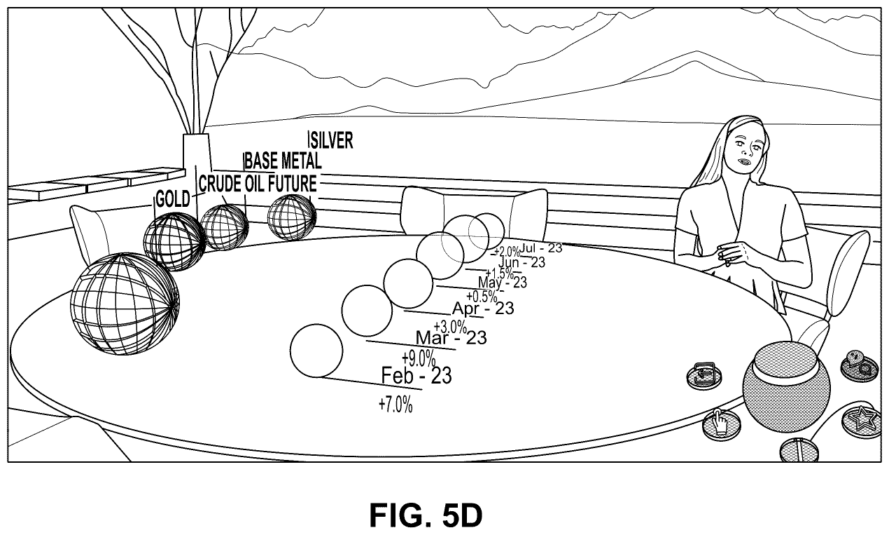

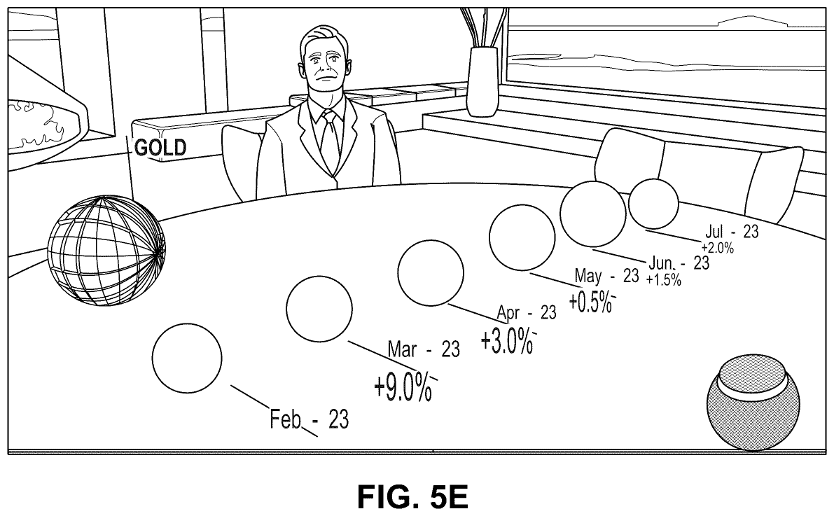

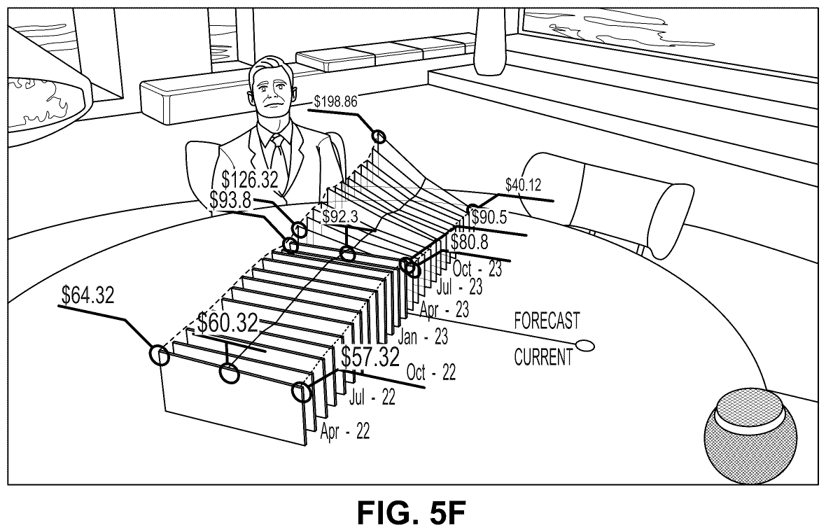

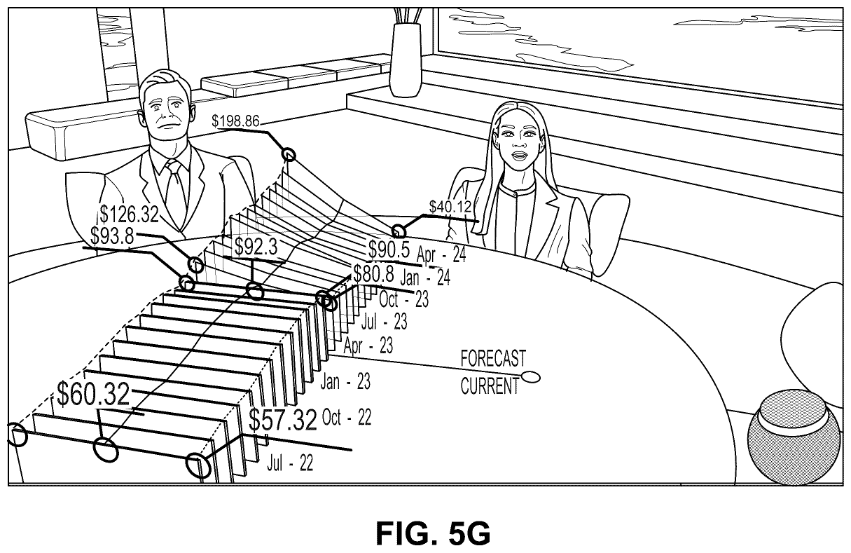

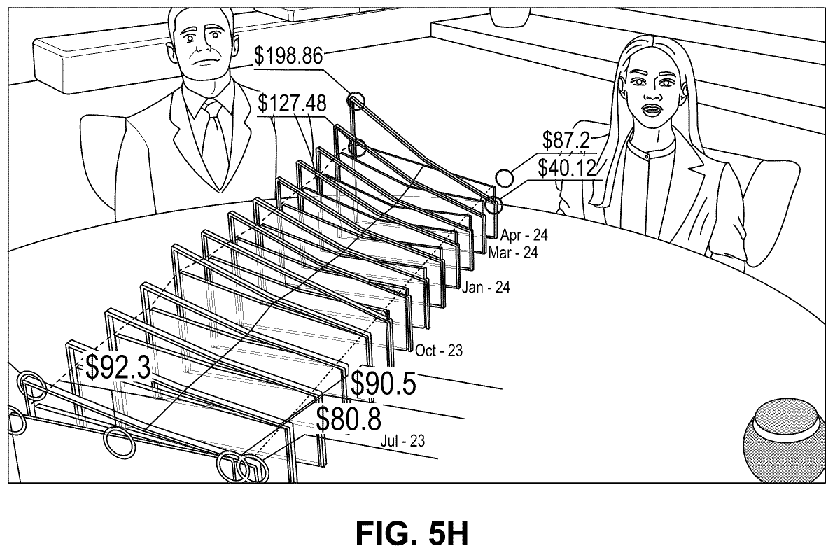

FIGS. 5A-5H illustrate an exemplary session in which a client end-user 105A interacts with platform end-users 105B in a 3D virtual environment 150 hosted by the virtual transaction platform 130. During the session, the 3D engine 145 generates a virtual scene 205 that includes virtual user representations 155 corresponding to the remotely situated participants, as well as various transactional infographics 170 that are configurable in different states to present data visualizations 173 relating to the transaction data 161 of the client end-user 105A.

FIG. 5A illustrates a 3D virtual environment 150 in which a client end-user 105A initiates or joins a new virtual session using a client device 110A. Upon initiating or joining the session, the virtualization system 140 can generate a new instance of a 3D virtual environment 150 that is hosted on the servers 120 (e.g., cloud servers 120A) and the 3D engine 145 can render a virtual scene 205 (e.g., using 3D scene definition data 202) within the 3D virtual environment 150. Additionally, the 3D engine 145 generates and inserts a virtual user representation 155A corresponding to the client end-user 105A into the virtual scene 205. As explained above, the virtual user representation 155A may be based on a live video stream that is transmitted from the client device 110A to the virtualization system 140 in real-time by a camera device situated locally with respect to the client end-user 105A. Alternatively, the virtual user representation 155A may correspond to a static image or object (e.g., associated the client end-user's profile) that is associated with the client end-user 105A.

In this example, the 3D virtual environment 150 includes a virtual scene 205 corresponding to a conference room. The 3D engine 145 generates the virtual scene 205 using 3D scene definition data 202 that defines the dimensions of the conference room and various background objects 204 within the virtual room (e.g., such as objects 171 corresponding to a table, chairs, and background appearance). The 3D engine 145 additionally generates and inserts the virtual user representation 155A corresponding to the client end-user 105A into the virtual scene. To simulate the feeling of a meeting in a real-world environment, the virtual user representation 155A can be inserted into the virtual scene at a location of object corresponding to a seat or chair object to simulate the client-end-user 105A as being seated at a table in the conference room setting.

As shown in FIGS. 5D-5H, one or multiple platform end-users 105B can join the session at any point in time using their respective client devices 110B. In some instances, the client end-user 105A may schedule a date and time to meet with one or more platform end-users 105B and all of the end-users may join the 3D virtual session at the scheduled time. Additionally, or alternatively, after a client end-user 105A has joined a session, the client end-user 105A can transmit a request for one or more platform end-users 105B to join the session. The 3D engine 145 may insert a separate virtual user representation 155B into the 3D virtual environment 150 for each platform end-user 105B that joins the session. Each of these virtual user representations 155 can be inserted into a seat or chair object arranged around a table object included within the virtual scene. Additionally, if desired, invited end-users 105C also can be sent invitations to join the session and corresponding virtual user representations can be inserted for each invited end-user that joins.

In FIG. 5B, the 3D engine 145 generates and inserts a transactional infographic 170 into the virtual scene which presents an asset data visualization 173A summarizing some or all of the transaction data 161 associated with the client end-user 105A. The asset data visualization 173A can be generated, at least in part, by accessing the client end-user's transaction data 161 (e.g., electronic asset information 410) stored on a transactions system 160. In this example, the asset data visualization 173A comprises a plurality of objects 171, each of which corresponds to an asset category (e.g., crypto, art, cash, fixed income, and commodities) identified by the transaction data 161. Each of the objects 171 are annotated with textual indicators identifying a value of a corresponding asset category.

In FIG. 5C, the 3D engine 145 generates and inserts two additional transactional infographics 170 into the virtual scene 205, which present a performance data visualization 173B and a risk data visualization 173C. In this example, the performance data visualization 173B includes a object comprising a mapping or graph which illustrates historical performance information for each of the asset categories identified by the asset data visualization 173A. The performance data visualization 173B can be generated and/or customized using the historical asset data 430 retrieved from the transaction system 160 for the client end-user 105A. The risk data visualization 173C includes an object comprising a mapping or graph which illustrates a risk or exposure level for each of the asset categories. The risk data visualization 173C can be generated and/or customized based on asset analytics data 440 retrieved from the transaction system 160 and/or based on outputs of analytics functions that are integrated with the 3D virtual environment itself.

In FIGS. 5D-5E, the 3D engine 145 generates and inserts a transactional infographic 170 into the virtual scene which presents a more granular performance data visualization 173B relating to one of the asset categories (in this example, the commodity assets). This transactional infographic 170 uses one or more objects 171 to visualize performance for the asset category over a period of time (e.g., by showing percentage gains/loss across a timeline). In some examples, the transactional infographic 170 shown may be transitioned to this state in response to an end-user 105 (e.g., the platform end-user 105B) selecting or interacting with the object 171 corresponding to commodity assets, which was presented by the presented in the initial asset data visualization 173A. Again, the performance data visualization 173B can be generated and/or customized by accessing the client end-user's historical asset data 430 stored on the transaction system 160.

In FIGS. 5F, the 3D engine 145 generates and inserts a transactional infographic 170 into the virtual scene which presents a projection data visualization 173D relating to an asset category (in this example, the commodity asset category) currently be discussed in this virtual session. The projection data visualization 173D illustrates both historical performance information and future projection information for the asset category. The projection data visualization 173D can be generated and/or customized based on asset analytics data 440 retrieved from the transaction system 160 and/or based on outputs of analytics functions that are integrated with the 3D virtual environment itself.

In FIGS. 5G-5H, the 3D engine 145 generates and inserts a transactional infographic 170 into the virtual scene 205 which presents a recommendation data visualization 173E relating to the asset category (again, the commodity assets) currently be discussed in the virtual session. The recommendation data visualization 173E utilizes one or more objects 171 to recommend changes or reallocations of the client end-user's investments and to visualize how those changes or reallocations are projected to impact the client end-user's investments. The recommendation data visualization 173E can be generated and/or customized using asset analytics data 440 retrieved from the transaction system 160 and/or based on outputs of analytics functions that are integrated with the 3D virtual environment itself.

Based on the interactions that occurred during the live 3D session, the client end-user 105A may agree to change his or her investments based on the recommendations or discussions that occurred during the virtual session. In this scenario, the client end-user 105A and/or the platform end-user 105B can initiate or execute one or more electronic transactions 165 to implement the investment modifications (e.g., in this case, to modify the client end-user's allocation of investments across the commodities sector).

The electronic transactions 165 can be initiated or executed in various ways. In some instances, the client end-user 105A and/or the platform end-user 105B can select a object 171 presented in connection with a transactional infographic 170 to initiate or execute the electronic transactions 165. In other examples, a GUI that displays the 3D virtual environment to the client end-user 105A and/or the platform end-user 105B may include a selectable option (or menu of selection options) to initiate or execute the electronic transactions 165.

When an electronic transaction 165 is initiated or executed during the virtual session, the virtualization system 140 may transmit a request to the transaction system 160 (e.g., via API 162). In turn, the transaction system 160 can initiate or execute the requested electronic transaction 165 and send a confirmation message to the virtualization system 140. A corresponding confirmation message can be displayed or visualized in the 3D virtual environment 150 (e.g., using one or more objects) to notify the end-user participants that the electronic transaction 165 has been processed or is being processed.

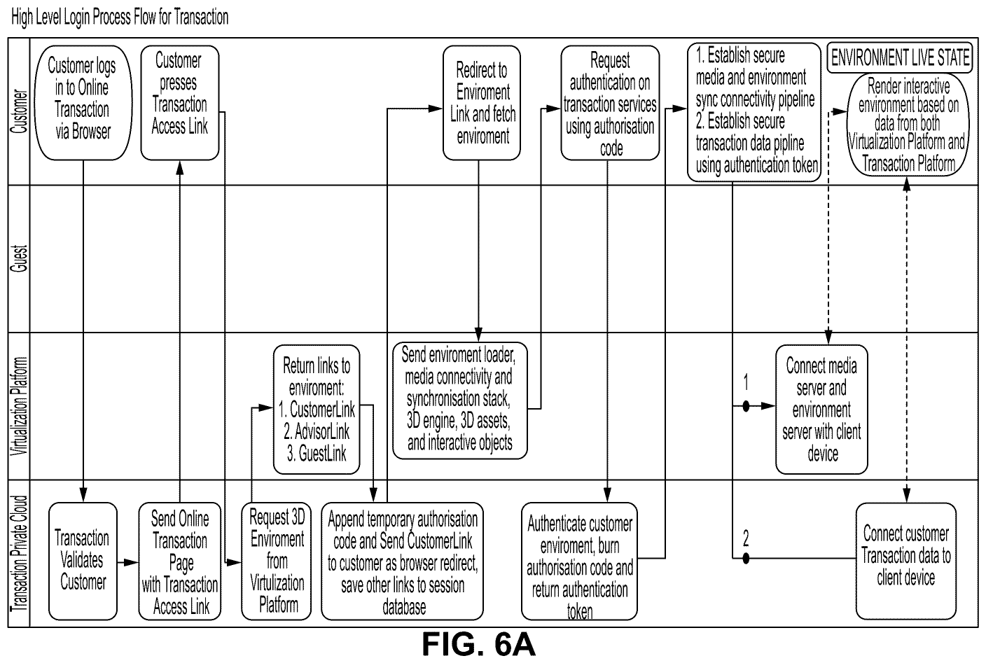

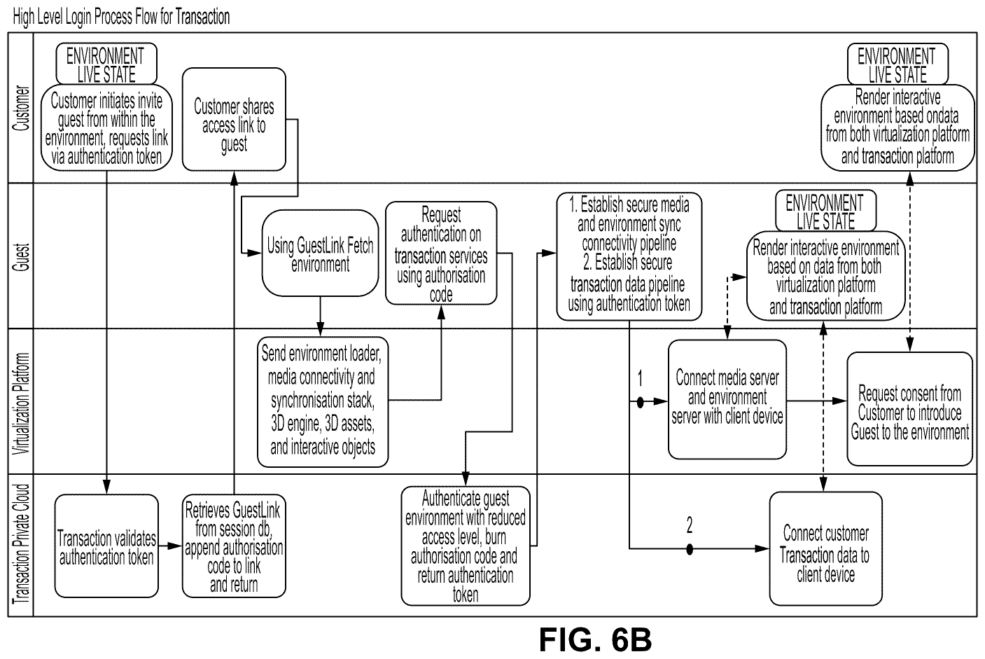

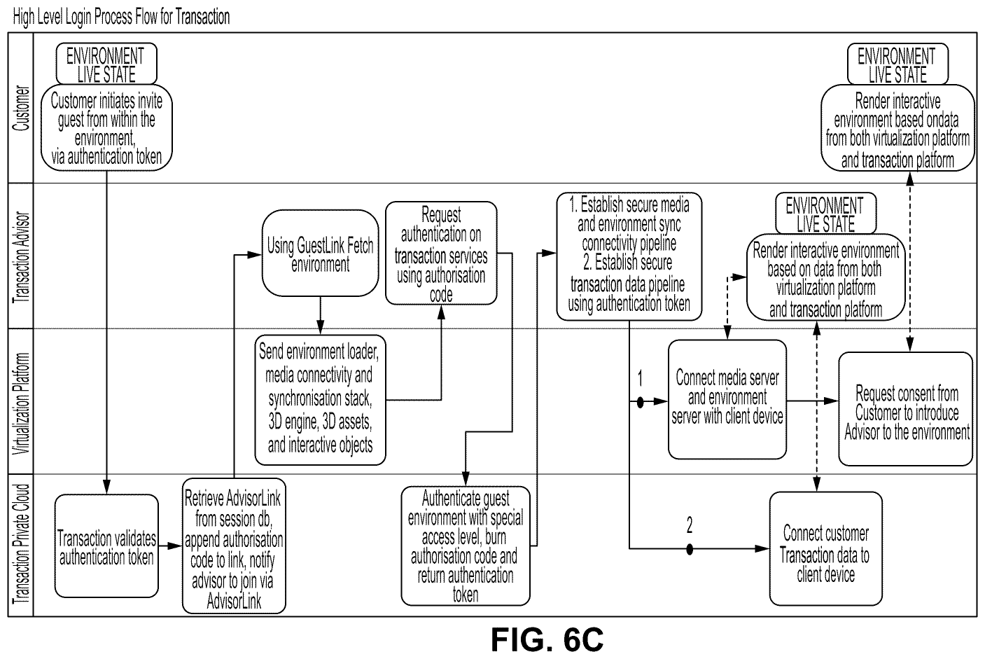

FIGS. 6A-6C illustrate exemplary process flows that can be executed by the systems described herein.

FIG. 6A is a flow diagram illustrating an exemplary process flow 600A that may be executed to provide a client end-user 105A with access to a 3D virtual session according to certain embodiments.

The process flow 600A is segmented into four rows and a leftmost column identifies exemplary devices that can perform the functionalities on the right side of the figure. In particular, the leftmost column identifies four devices: a customer device (e.g., which may include client device 110A); a guest device (e.g., which may include client device 110C); a virtualization platform server (e.g., which may include virtualization system 140, servers 120, or cloud servers 120A); and transaction private cloud (e.g., which may include transaction system 160, servers 120, or transaction system servers 120B).

In block 601, a customer device (e.g., client end-user 105A) logs into an online transaction system 160 using a web browser.

In block 602, a transaction private cloud server validates the customer.

In block 603, the transaction private cloud server generates a GUI for presentation on the customer device. The GUI may include information related to the customer's transaction data 161 (e.g., banking data or financial services data) and/or products or services offered by a financial entity. The GUI also may include an electronic link (e.g., a hyperlink) that can be selected to request or initiate a 3D virtual session.

In block 604, an end-user (e.g., a client end-user 105A) selects the electronic access link using the customer device.

In block 605, the transaction private cloud server transmits a request to a virtualization platform server to create or initialize a new 3D virtual session.

In block 606, the virtualization platform server creates or initializes the new 3D virtual session (e.g., which may include creating or initializing a new 3D virtual environment 150) and generates three electronic access links that can be utilized to access the 3D virtual session. A first link enables a customer (or client end-user 105A) to access the 3D virtual session, a second enables an advisor (or platform end-user 105B) to access the 3D virtual session, and a third link enables a guest (or invited end-user 105C) to access the 3D virtual session. Each of the links are transmitted by the virtualization platform server to the transaction private cloud server.

In block 607, the transaction private cloud server generates a temporary authorization code and appends the code to the first link. The appended link is then transmitted to the customer device as a browser redirect. Additionally, the transaction private cloud server stores the electronic access links (or at least the second and third links) in a session database.

In block 608, the customer device receives the appended link from the transaction private cloud server causing the web browser of the customer device to be redirected to the 3D virtual session hosted on the virtualization platform server. The browser also fetches the 3D virtual session (or corresponding 3D virtual environment) from the virtualization platform server.

In block 609, the virtualization platform server transmits data to the customer device for providing the 3D virtual environment to the customer device. This can include sending environment loader data, media connectivity data, synchronization stack data, 3D engine data, 3D transaction or asset data, interactive objects and/or other data that enables the customer device to load and access the 3D virtual session via the web browser.

In block 610, the customer device sends an authentication request to the transaction private cloud server which includes the authorization code.

In block 611, the transaction private cloud server authenticates the customer device and transmits an authentication token to the customer device. In some instances, the transaction private cloud server also may delete, deactivate, or remove the temporary authorization code.

In block 612, upon receiving the authentication token, the customer device establishes a first connectivity pipeline with the virtualization platform server for secure media and environment synchronization, and a second connectivity pipeline with the transaction private cloud server using the authentication token.

In block 613, the virtualization platform server connects the customer device with a media server and an environment server for the virtual session.

In block 614, the transaction private cloud server connects the customer device to the transaction data (e.g., banking or financial data).

In block 615, the customer device (or web browser) is configured in a live state that is able to access the virtual session. The customer device (or web browser) renders the corresponding 3D virtual environment for the session using data from the virtualization platform server (or virtualization system) and data from the transaction private cloud server (or transaction system).

FIG. 6B is a flow diagram illustrating an exemplary process flow 600B that may be executed to provide an invited end-user 105C with access to a 3D virtual session according to certain embodiments.

The process flow 600B is segmented into four rows and a leftmost column identifies exemplary devices that can perform the functionalities on the right side of the figure. In particular, the leftmost column identifies four devices: a customer device (e.g., which may include client device 110A); a guest device (e.g., which may include client device 110C); a virtualization platform server (e.g., which may include virtualization system 140, servers 120, or cloud servers 120A); and transaction private cloud (e.g., which may include transaction system 160, servers 120, or transaction system servers 120B).

In block 621, the customer device is already configured in a live state with access to the virtual session (e.g., using the process flow 600A described above). In the live state, the customer device initiates a request to invite a guest to the virtual session and transmits the request to the transaction private cloud server using the authentication token (e.g., the authentication token received in block 612 above).

In block 622, the transaction private cloud server validates the authentication token.

In bock 623, the transaction private cloud server retrieves an electronic access link from a session database (e.g., the third link stored in block 607 above), appends an authorization code to the link, and transmits the appended link to the customer device.

In block 624, the customer device shares or transmits the appended electronic access link with a guest device (e.g., client device 110C).

In block 625, the guest device uses the appended electronic access link to fetch the fetch the 3D virtual environment associated with the virtual session from the virtualization platform server.

In block 626, the virtualization platform server transmits data to the guest device for providing the 3D virtual environment to the guest device. This can include sending environment loader data, media connectivity data, synchronization stack data, 3D engine data, 3D transaction or asset data, interactive objects and/or other data that enables the guest device to load and access the 3D virtual session via a web browser.

In block 627, the guest device uses the authorization code included with the electronic access link to request authentication from the transaction private cloud server.

In block 628, the transaction private cloud server authenticates the guest environment with a reduced access level (e.g., which may be limited by assigning more restrictive access privileges 185) and transmits an authentication token to the guest device. In some instances, the transaction private cloud server also may delete, deactivate, or remove the temporary authorization code provided to the guest device.

In block 629, upon receiving the authentication token, the guest device establishes a first connectivity pipeline with the virtualization platform server for secure media and environment synchronization, and a second connectivity pipeline with the transaction private cloud server using the authentication token.

In block 630, the virtualization platform server connects the guest device with a media server and an environment server for the virtual session.

In block 631, the transaction private cloud server connects the guest device to the transaction data (e.g., banking or financial data) associated with the customer end-user.

In block 632, the virtualization platform server can optionally send a consent request to the customer device which requests the customer end-user to approve introduction of the guest end-user into the session.

In block 633, the customer device sends a response to the virtualization platform server approving the guest end-user.

In block 634, the guest device (or web browser) is configured in a live state that is able to access the virtual session. The guest device (or web browser) renders the corresponding 3D virtual environment for the session using data from the virtualization platform server (or virtualization system) and data from the transaction private cloud server (or transaction system).

FIG. 6C is a flow diagram illustrating an exemplary process flow 600C that may be executed to provide a platform end-user 105C with access to a 3D virtual session according to certain embodiments.

The process flow 600B is segmented into four rows and a leftmost column identifies exemplary devices that can perform the functionalities on the right side of the figure. In particular, the leftmost column identifies four devices: a customer device (e.g., which may include client device 110A); an advisor device (e.g., which may include client device 110B); a virtualization platform server (e.g., which may include virtualization system 140, servers 120, or cloud servers 120A); and transaction private cloud (e.g., which may include transaction system 160, servers 120, or transaction system servers 120B).

In block 641, the customer device is already configured in a live state with access to the virtual session (e.g., using the process flow 600A described above). In the live state, the customer device initiates a request to invite an adviser (e.g., a platform end-user 105B) to the virtual session and transmits the request to the transaction private cloud server using the authentication token (e.g., the authentication token received in block 612 above).

In block 642, the transaction private cloud server validates the authentication token.

In block 643, the transaction private cloud server retrieves an electronic access link from a session database (e.g., the second link stored in block 607 above), appends an authorization code to the link, and transmits the appended link to the advisor device.

In block 644, the advisor device uses the appended electronic access link to fetch the fetch the 3D virtual environment associated with the virtual session from the virtualization platform server.

In block 645, the virtualization platform server transmits data to the advisor device for providing the 3D virtual environment to the advisor device. This can include sending environment loader data, media connectivity data, synchronization stack data, 3D engine data, 3D transaction or asset data, interactive objects and/or other data that enables the advisor device to load and access the 3D virtual session via a web browser.

In block 646, the advisor device uses the authorization code included with the electronic access link to request authentication from the transaction private cloud server.

In block 647, the transaction private cloud server authenticates the advisor environment with a special access level (e.g., which may include broad access privileges 185) and transmits an authentication token to the advisor device. In some instances, the transaction private cloud server also may delete, deactivate, or remove the temporary authorization code provided to the advisor device.

In block 648, upon receiving the authentication token, the advisor device establishes a first connectivity pipeline with the virtualization platform server for secure media and environment synchronization, and a second connectivity pipeline with the transaction private cloud server using the authentication token.

In block 649, the virtualization platform server connects the advisor device with a media server and an environment server for the virtual session.

In block 650, the transaction private cloud server connects the advisor device to the transaction data (e.g., banking or financial data) associated with the customer end-user.

In block 651, the virtualization platform server can optionally send a consent request to the customer device which requests the customer end-user to approve introduction of the advisor end-user into the session.

In block 652, the customer device sends a response to the virtualization platform server approving the advisor end-user.

In block 653, the advisor device (or web browser) is configured in a live state that is able to access the virtual session. The adviser device (or web browser) renders the corresponding 3D virtual environment for the session using data from the virtualization platform server (or virtualization system) and data from the transaction private cloud server (or transaction system).

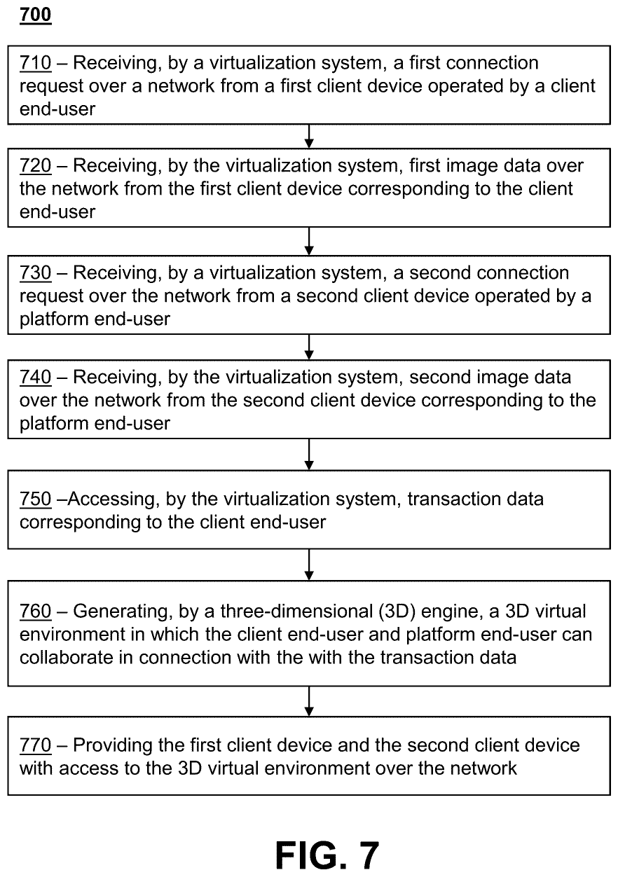

FIG. 7 illustrates a flow chart for an exemplary method 700 according to certain embodiments. Method 700 is merely exemplary and is not limited to the embodiments presented herein. Method 700 can be employed in many different embodiments or examples not specifically depicted or described herein. In some embodiments, the steps of method 700 can be performed in the order presented.

In other embodiments, the activities of method 700 can be performed in any suitable order. In still other embodiments, one or more of the steps of method 700 can be combined or skipped. In many embodiments, system 100A, 100B, 100C, virtual transaction platform 130, virtualization system 140, and/or transaction system 160 can be configured to perform method 700 and/or one or more of the steps of method 700. In these or other embodiments, one or more of the steps of method 700 can be implemented as one or more computer instructions configured to run at one or more processing devices 101 and configured to be stored at one or more non-transitory computer storage devices (e.g., memory devices 102). Such non-transitory memory storage devices can be part of a computer system such as system 100A, 100B, 100C, virtual transaction platform 130, virtualization system 140, and/or transaction system 160. The processing device(s) 101 and memory devices 102 can be similar or identical to those described above.

In step 710, a virtualization system 140 receives a first connection request over a network 155 from a first client device 110 operated by a client end-user 105A.

In step 720, the virtualization system 140 receives first image data over the network 115 from the first client device 110 corresponding to the client end-user 105A. In some scenarios, the image data may comprise real-time video streaming data 201 generated by a camera or video device included on, or in communication with, the first client device. In other scenarios, the image data may comprise a static image or object.

In step 730, the virtualization system 140 receives a second connection request over the network 115 from a second client device 110 operated by a platform end-user 105B.

In step 740, the virtualization system 140 receives second image data over the network 115 from the second client device 110 corresponding to the platform end-user 105B. In some scenarios, the image data may comprise real-time video streaming data 201 generated by a camera or video device included on, or in communication with, the first client device. In other scenarios, the image data may comprise a static image or object.

In step 750, the virtualization system 140 accesses transaction data 161 corresponding to the client end-user 105A. In some scenarios, the virtualization system 140 may retrieve the transaction data 161 from a transaction system 160. For example, the transaction system 160 may include an API 162 that enables the virtualization system 140 to retrieve the transaction data 161.

In step 760, a 3D engine 145 generates a 3D virtual environment 150 in which the client end-user 105A and platform end-user 105B can collaborate in connection with the with the transaction data 161. The 3D engine 145 may be a component of the virtualization system 140. In some examples, generating the 3D virtual environment 150 can include: generating a first virtual user representation corresponding to the client end-user based, at least in part, on the first image data; generating a second virtual user representation corresponding to the platform end-user based, at least in part, on the second image data; generating one or more transactional infographics based, at least in part, on the transaction data 161; and/or incorporating the first virtual user representation, the second virtual user representation, and/or the one or more transactional infographics into the 3D virtual environment.

In step 770, the first client device and the second client device are provided with access to the 3D virtual environment over the network

As evidenced by the disclosure herein, the inventive architecture and techniques set forth in this disclosure are rooted in computer technologies that overcome existing problems in known remote collaboration systems, including problems dealing with low levels of realism, lack of user presence, and lack of functionalities provided by traditional 2D remote collaboration solutions. The architecture and techniques described in this disclosure provide a technical solution (e.g., one 3D virtualization settings, interactive infographics, etc.) for overcoming the limitations associated with known architecture and techniques. This technology-based solution marks an improvement over existing system capabilities and functionalities of remote collaboration solutions by generating virtual environments that facilitate collaboration and interactions among remote participants in a 3D setting that is akin to real-world or in-person meetings, and permitting electronic transactions to be initiated or executed directly within 3D virtual environments without having to access or launch separate applications.

Furthermore, in a number of embodiments, the techniques described herein can solve a technical problem that arises only within the realm of computer systems, because 3D virtualization systems do not exist outside the realm of computer networks.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium, such as a semiconductor or solid-state memory, magnetic tape, a removable computer diskette, a random-access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

It should be recognized that any features and/or functionalities described for an embodiment in this application can be incorporated into any other embodiment mentioned in this disclosure. Moreover, the embodiments described in this disclosure can be combined in various ways. Additionally, while the description herein may describe certain embodiments, features, or components as being implemented in software or hardware, it should be recognized that any embodiment, feature, or component that is described in the present application may be implemented in hardware, software, or a combination of the two.

While various novel features of the invention have been shown, described, and pointed out as applied to particular embodiments thereof, it should be understood that various omissions and substitutions, and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding of the teachings of the invention, that the particular hardware and devices that are part of the system described herein, and the general functionality provided by and incorporated therein, may vary in different embodiments of the invention. Accordingly, the description of system components is for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation. Variations, modifications, and other implementations of what is described herein may occur to those of ordinary skill in the art without departing from the spirit and scope of the present invention and its claims.

1. A computerized method for facilitating collaboration and presentation of transaction data in a virtual environment, comprising:
receiving, by a virtualization system, a first connection request over a network from a first client device operated by a client end-user;
receiving, by the virtualization system, first image data over the network from the first client device corresponding to the client end-user;
receiving, by a virtualization system, a second connection request over the network from a second client device operated by a platform end-user;
receiving, by the virtualization system, second image data over the network from the second client device corresponding to the platform end-user;
accessing, by the virtualization system, transaction data corresponding to the client end-user;
generating, by a three-dimensional (3D) engine associated with the virtualization system, a 3D virtual environment in which the client end-user and platform end-user can collaborate in connection with the with the transaction data, wherein generating the 3D virtual environment includes:
generating, by the 3D engine, a first virtual user representation corresponding to the client end-user based, at least in part, on the first image data;
generating, by the 3D engine, a second virtual user representation corresponding to the platform end-user based, at least in part, on the second image data;
generating, by the 3D engine, one or more transactional infographics based, at least in part, on the transaction data;
incorporating the first virtual user representation, the second virtual user representation, and the one or more transactional infographics into the 3D virtual environment; and
providing the first client device and the second client device with access to the 3D virtual environment over the network.

2. The computerized method of claim 1, wherein the method further includes:
initiating or executing an electronic transaction in response to one or more interactions within the 3D virtual environment.

3. The computerized method of claim 2, wherein:
the virtualization system is in communication with a transaction system that stores the transaction data corresponding to the client end-user;
the transaction system comprises an application programming interface (API); and
the virtualization system communicates with the transaction system via the API to access the transaction data corresponding to the client end-user and to initiate or execute the electronic transaction.

4. The computerized method of claim 1, wherein:
the one or more transactional infographics are configured to present one or more data visualizations associated with the transaction data within the 3D virtual environment;
the one or more data visualizations each include one or more objects or multimedia content; and
generating the one or more data visualizations comprises customizing the one or more objects or the multimedia content, at least in part, using the transaction data.

5. The computerized method of claim 4, wherein the one or more transactional infographics are configured to present an asset data visualization, and generating the asset data visualization comprises configuring the one or more objects or the multimedia content to present a summary of the transaction data within the 3D virtual environment.

6. The computerized method of claim 4, wherein the one or more transactional infographics are configured to present a performance data visualization, and generating the performance data visualization comprises integrating historical asset data into the one or more objects or the multimedia content presented within the 3D virtual environment.

7. The computerized method of claim 4, wherein the one or more transactional infographics are configured to present a recommendation data visualization, and generating the recommendation data visualization comprises configuring the one or more objects or the multimedia content to present recommendations specified by the platform end-user within the 3D virtual environment.

8. The computerized method of claim 4, wherein:
the one or more transactional infographics are configured to present a projection data visualization and a risk data visualization; and
generating the projection data visualization and the risk data visualization comprises integrating asset analytics data into the one or more objects or the multimedia content presented within the 3D virtual environment.

9. The computerized method of claim 1, wherein the method further includes:
assigning, by an access control system, access privileges to each end-user that accesses the 3D virtual environment, including the client end-user and the platform end-user.

10. The computerized method of claim 8, wherein the access privileges control permissions of the client end-user and the platform end-user within the 3D virtual environment, including permissions related to viewing or accessing the transaction data within the 3D virtual environment and permissions related to initiating or executing electronic transactions within the 3D virtual environment.

11. The computerized method of claim 1, wherein the 3D engine is configured to execute generative artificial intelligence (AI) functions to generate the first virtual user representation, the second virtual user representation, the one or more transactional infographics, or a virtual scene for the 3D virtual environment.

12. A system comprising one or more processing devices and one or more non-transitory memory devices for storing instructions, wherein execution of the instructions by the one or more processing devices causes the one or more computing devices to perform functions comprising:
receiving, by a virtualization system, a first connection request over a network from a first client device operated by a client end-user;
receiving, by the virtualization system, first image data over the network from the first client device corresponding to the client end-user;
receiving, by a virtualization system, a second connection request over the network from a second client device operated by a platform end-user;
receiving, by the virtualization system, second image data over the network from the second client device corresponding to the platform end-user;
accessing, by the virtualization system, transaction data corresponding to the client end-user;
generating, by a three-dimensional (3D) engine associated with the virtualization system, a 3D virtual environment in which the client end-user and platform end-user can collaborate in connection with the with the transaction data, wherein generating the 3D virtual environment includes:
generating, by the 3D engine, a first virtual user representation corresponding to the client end-user based, at least in part, on the first image data;
generating, by the 3D engine, a second virtual user representation corresponding to the platform end-user based, at least in part, on the second image data;
generating, by the 3D engine, one or more transactional infographics based, at least in part, on the transaction data;
incorporating the first virtual user representation, the second virtual user representation, and the one or more transactional infographics into the 3D virtual environment; and
providing the first client device and the second client device with access to the 3D virtual environment over the network.

13. The system of claim 12, wherein execution of the instructions by the one or more processing devices causes the one or more computing devices to initiate or execute an electronic transaction in response to one or more interactions within the 3D virtual environment.

14. The system of claim 13, wherein:
the virtualization system is in communication with a transaction system that stores the transaction data corresponding to the client end-user;
the transaction system comprises an application programming interface (API); and
the virtualization system communicates with the transaction system via the API to access the transaction data corresponding to the client end-user and to initiate or execute the electronic transaction.

15. The system of claim 12, wherein:
the one or more transactional infographics are configured to present one or more data visualizations associated with the transaction data within the 3D virtual environment;
the one or more data visualizations each include one or more objects or multimedia content; and
generating the one or more data visualizations comprises customizing the one or more objects or the multimedia content, at least in part, using the transaction data.

16. The system of claim 15, wherein:
the one or more transactional infographics are configured to present an asset data visualization, and generating the asset data visualization comprises configuring the one or more objects or the multimedia content to present a summary of the transaction data within the 3D virtual environment;
the one or more transactional infographics are configured to present a performance data visualization, and generating the performance data visualization comprises integrating historical asset data into the one or more objects or the multimedia content presented within the 3D virtual environment; or
the one or more transactional infographics are configured to present a recommendation data visualization, and generating the recommendation data visualization comprises configuring the one or more objects or the multimedia content to present recommendations specified by the platform end-user within the 3D virtual environment.

17. The system of claim 15, wherein:
the one or more transactional infographics are configured to present a projection data visualization and a risk data visualization; and
generating the projection data visualization and the risk data visualization comprises integrating asset analytics data into the one or more objects or the multimedia content presented within the 3D virtual environment.

18. The system of claim 12, wherein:
execution of the instructions by the one or more processing devices causes the one or more computing devices to assign access privileges to each end-user that accesses the 3D virtual environment, including the client end-user and the platform end-user; and
the access privileges control permissions of the client end-user and the platform end-user within the 3D virtual environment, including permissions related to viewing or accessing the transaction data within the 3D virtual environment and permissions related to initiating or executing electronic transactions within the 3D virtual environment.

19. The system of claim 12, wherein the 3D engine is configured to execute generative artificial intelligence (AI) functions to generate the first virtual user representation, the second virtual user representation, the one or more transactional infographics, or a virtual scene for the 3D virtual environment.

20. A system for facilitating collaboration and presentation of transaction data in a virtual environment, comprising:
one or more cloud servers comprising one or more processing devices and one or more memory devices storing instructions, wherein execution of the instructions by the one or more processing devices causes the one or more cloud servers to perform functions comprising:
receiving, by a virtualization system, a first connection request over a network from a first client device operated by a client end-user;
receiving, by the virtualization system, first image data over the network from the first client device corresponding to the client end-user;
receiving, by a virtualization system, a second connection request over the network from a second client device operated by a platform end-user;
receiving, by the virtualization system, second image data over the network from the second client device corresponding to the platform end-user;
accessing, by the virtualization system, transaction data corresponding to the client end-user;
generating, by a three-dimensional (3D) engine associated with the virtualization system, a 3D virtual environment in which the client end-user and platform end-user can collaborate in connection with the with the transaction data, wherein generating the 3D virtual environment includes:
generating, by the 3D engine, a first virtual user representation corresponding to the client end-user based, at least in part, on the first image data;
generating, by the 3D engine, a second virtual user representation corresponding to the platform end-user based, at least in part, on the second image data;
generating, by the 3D engine, one or more transactional infographics based, at least in part, on the transaction data;
incorporating the first virtual user representation, the second virtual user representation, and the one or more transactional infographics into the 3D virtual environment; and
providing the first client device and the second client device with access to the 3D virtual environment over the network.
